(19) United States
(12) Patent Application Publication
(10) Pub. No.: US 2003/0014324 A1
(43) Pub. Date: Jan. 16, 2003

(54) Techniques for synthesizing and distributing personal care products

(76) Inventors: Don Roderick Donovan, Sebastopol, CA (US); Dennis Andrew Maloney, San Francisco, CA (US); Julie Marie Foy, Mason, OH (US); Thomas Matthew Schultz, Randolph, NJ (US); Jonathan James Grayson, San Francisco, CA (US); Elizabeth Murphy Schrader, San Francisco, CA (US); Kimberly Christa Gobel, San Francisco, CA (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/992,959

(22) Filed: Nov. 16, 2001

Related U.S. Application Data
(63) Continuation-in-part of application No. PCT/US01/21773, filed on Jul. 10, 2001.

(51) Int. Cl. G06F 17/60

(52) U.S. Cl. 705/26

(57) ABSTRACT

Methods and apparatus are described for synthesizing and distributing personal care products in a retail environment. Preference data are generated in the retail environment. The preference data are representative of expressed preferences of a consumer with regard to personal care. In response to the preference data, instructions for reproducibly synthesizing at least one personal care product are generated in a format perceivable and understandable by humans. The at least one personal care product is synthesized in the retail environment in accordance with the instructions. The at least one personal care product is provided to the consumer before the consumer leaves the retail environment.

### RELATED APPLICATION DATA

The present application claims priority from both U.S. patent application No. 09/389,933 filed on Sep. 3, 1999 and International Application No. PCT/US01/21773 filed on Jul. 10, 2001, the entire disclosures of which are both incorporated herein by reference for all purposes.

### BACKGROUND OF THE INVENTION

The present invention relates to techniques for synthesizing and distributing custom personal care products, and specifically to such techniques practiced in both e-commerce and retail settings.

In the world of commerce, there is considerable movement toward a more individualized approach to the delivery of goods and services to consumers. Advances in networking and information processing technology have enabled many different types of technology for identifying specific consumers and for directing marketing for goods and services to such consumers in manner most likely to appeal to them. Many of these technologies are embodied in an increasingly confusing array of online electronic commerce web sites.

However, such sites do not harness the full potential of available technology in that they do not typically involve the individual consumer in the creation of products for that specific consumer. That is, the level of customization of products on the Internet continues to lag behind the increasing expectations of consumers in this regard. In addition, by their very nature, e-commerce web sites lack certain characteristics which are of primary importance to a significant number of consumers, i.e., personal attention and individualized service.

It is therefore desirable that currently available networking and information processing technology be exploited to provide a higher level of individualized service on e-commerce web sites. It is also desirable that such technology be further leveraged in retail environments such that the needs and desires of the individual consumer are not compromised.

### SUMMARY OF THE INVENTION

According to the invention, various embodiments are described herein by which information provided by the consumer is used to provide a highly individualized shopping experience. Some of these embodiments are described in the online e-commerce context. Others are described in the context of retail environments. It will be understood that various aspects of each of the described embodiments may be employed in others of the described embodiments without departing from the scope of the invention.

According to specific embodiments, methods and apparatus are provided for synthesizing and distributing beauty and personal care products in a retail environment. Preference data are generated in the retail environment. The preference data are representative of expressed preferences of a consumer with regard to personal care. In response to the preference data, instructions for reproducibly synthesizing at least one personal care product are generated in a format perceivable and understandable by humans. The at least one personal care product is synthesized in the retail environment in accordance with the instructions. The at least one personal care product is provided to the consumer before the consumer leaves the retail environment.

According to other specific embodiments, methods and apparatus are provided for synthesizing a plurality of personal care products. Preference data representative of the expressed preferences of a consumer with regard to personal care are generated substantially simultaneously. In response to the preference data, instructions for synthesizing each of the plurality of personal care products are generated. Each of the personal care products is then synthesized in accordance with the instructions. According to various and more specific embodiments, these embodiments of the invention may be implemented in both retail environments and virtual environments (e.g., over a wide area network such as the internet) to create customized systems of customized personal care products.

A further understanding of the nature and advantages of the present invention may be realized by reference to the remaining portions of the specification and the drawings.

### BRIEF DESCRIPTION OF THE DRAWINGS

FIG. 1 depicts a simplified flowchart of the steps performed in an exemplary method of providing a customized product combination to a consumer in accordance with the present invention.

FIG. 2 depicts a simplified flowchart of the additional steps performed in a preferred embodiment of the method of providing a customized product combination to a consumer in accordance with the present invention.

FIG. 3 depicts a simplified flowchart of the additional steps which are preferably performed in a preferred embodiment of the method of providing a customized product combination to a consumer in accordance with the present invention.

FIG. 4 depicts a simplified flowchart of the steps performed in another preferred embodiment of the method of providing a customized product combination to a consumer in accordance with the present invention.

FIG. 5 depicts a simplified flowchart of the steps performed by the method for a personalized product-related service in accordance with the present invention.

FIG. 6 is a schematic illustration of a computer system suitable for use with the present invention.

FIG. 7 is a schematic illustration of an apparatus for providing customized products to a consumer in accordance with the present invention.

FIG. 8 is a schematic illustration of an apparatus for providing customized products to a consumer in accordance with the present invention.

FIG. 9 depicts a simplified flowchart of the steps performed by an exemplary network-based method for providing a customized product combination to a consumer in accordance with the present invention.

FIG. 10 depicts a simplified flowchart of the steps performed by a method suitable for use in electronic shopping for providing customized product-related services to a consumer in accordance with the present invention.

FIGS. 11 and 12 depict illustrations of an exemplary consumer profiling questionnaire for use in the present invention.

FIGS. 13 and 14 depict illustrations of exemplary additional profiling data specific to a product category to be obtained from a consumer.

FIG. 15 depicts an illustration of an exemplary list of products corresponding to the consumer profiling data obtained in accordance with the present invention.

FIG. 16 depicts an illustration of an exemplary product specific questionnaire for a selected product in accordance with the cosmetic application.

FIG. 17 depicts an example of a user interface showing a customized product and providing the consumer the option to further customize the product in the cosmetic application.

FIGS. 18 and 19 depict illustrations of exemplary user screens for customizing options provided to the consumer in accordance with the present invention.

FIG. 20 depicts an illustration of an exemplary list of products corresponding to the consumer profiling data in which the product has been customized in accordance with the present invention.

FIG. 21 illustrates a fragrance triangle partitioned into two fragrance areas used to select a first fragrance and a second fragrance in accordance with one embodiment of the invention.

FIG. 22 illustrates a flow diagram for selecting first and second fragrances to form a customized fragrance in accordance with one embodiment of the invention.

FIG. 23 illustrates a flow diagram for selecting a first fragrance in accordance with one embodiment of the invention.

FIG. 24 illustrates a flow diagram for selecting a second fragrance in accordance with one embodiment of the invention.

FIG. 25 is an illustration of a retail environment in which various embodiments of the present invention may be practiced.

FIG. 26 is a flowchart illustrating a generalized embodiment of the invention practiced in a retail environment.

FIG. 27 is a flowchart illustrating a method for synthesizing a custom fragrance according to a specific embodiment of the present invention.

FIG. 28-33 are screen shots illustrating exemplary graphical user interfaces by which various embodiments of the invention may be practiced.

FIG. 34 is a flowchart illustrating a method for synthesizing a personal care product formulation according to a specific embodiment of the present invention.

FIGS. 35-43 are screen shots illustrating exemplary graphical user interfaces by which various embodiments of the invention may be practiced.

FIG. 44 is a flowchart illustrating a method for simultaneously synthesizing a plurality of personal care products according to a specific embodiment of the present invention.

### DETAILED DESCRIPTION OF SPECIFIC EMBODIMENTS

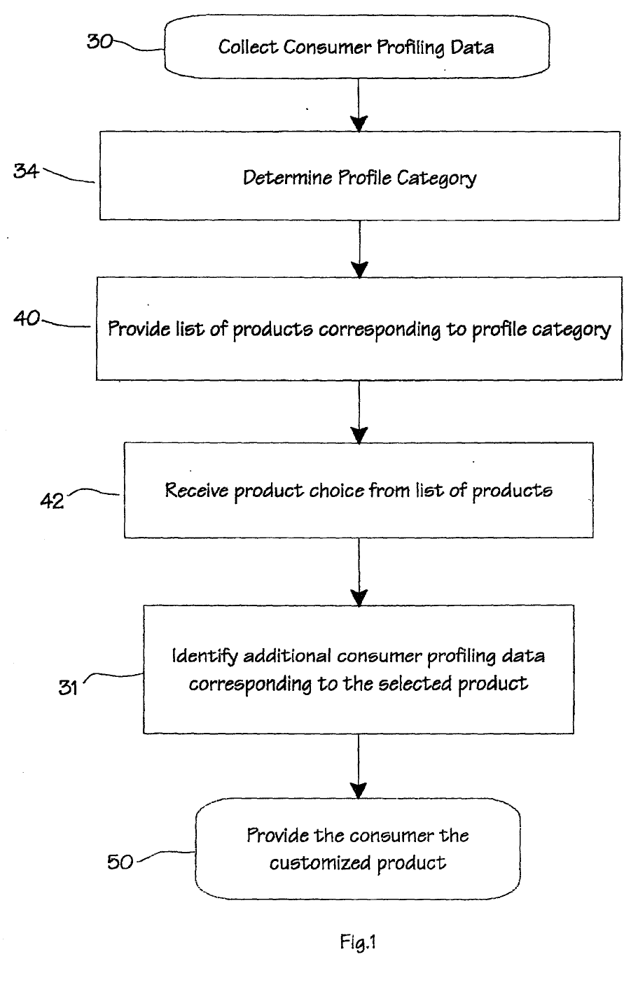

One embodiment of the present invention is illustrated in the flowchart of FIG. 1 which depicts a method of providing a customized product combination to a consumer in accordance with one aspect of the present invention. The method comprises the steps of collecting consumer profiling data (30) about a consumer. Consumer profiling data may be collected through a user interface, direct interaction over a telephone, in-person consultations, E-mail, handwritten questionnaires, test kits, etc. The consumer profiling data preferably comprises psychological preferences and physiological conditions of the consumer. For example, in a beauty care example, the physiological data comprises hair length, hair type, hair color, eye color, skin type, skin attitude, etc. Preferred psychological data comprises preferred colors and styles, lifestyle, life stage, attitude, desired look of hair, desired look of face and level of involvement. A consumer profiling category is then determined (34) which corresponds to the consumer profiling data. To determine the consumer profiling category, the consumer's responses to the profiling data inquiries are matched against a decision tree. The decision tree comprises potential combinations of the consumer responses to the consumer profiling information. Preferably, the decision trees are converted to mathematical algorithms which process the decision trees electronically to ascertain the appropriate category to assign the consumer. The decision trees for initial category profiles preferably are based on historical consumer research data for consumers having similar factors. The consumer may be assigned various profile sub-categories which correspond to specific product categories (such as hair care, skin care, cosmetics, fragrances, etc.). The consumer is provided a list of one or more products (40) that correspond to the consumer profiling category. In a specific embodiment, the list of products comprises consumer services. In a more specific embodiment, the list of products comprises consumer goods (such as beauty care products, clothing, electronics, etc.). Preferably, the list of products is retrieved from a data repository of consumer profiles. The list of products corresponds to a specific profile category or sub-category. A product choice selected from the list is received (42) from the consumer. The selection may be through a user interface such as a web browser or kiosk, or through direct interaction such as during a telephone call or personal consultation. Additional consumer profiling data (31) which corresponds to the selected product choice is identified from the consumer. The additional profiling data comprises product form, feature and expectation preferences. Typical form preferences comprise the type of the product (such as 2-in-1 shampoo and conditioner, foaming cleanser or lotion for facial cleanser, etc.). Preferred feature preferences comprise UV protection in cosmetic or skin care products, level of fragrance in the product, etc. In one embodiment, the additional profiling data is identified and collected through a user interface in which the consumer is presented questions which elicit the consumer profiling data. The collection of the additional profiling data may also comprise mailing surveys or test kits to a consumer, in-person consultation, or direct interaction such as during a telephone call. The consumer is provided a customized product (50) which corresponds to the additional consumer profiling data and the selected product choice.

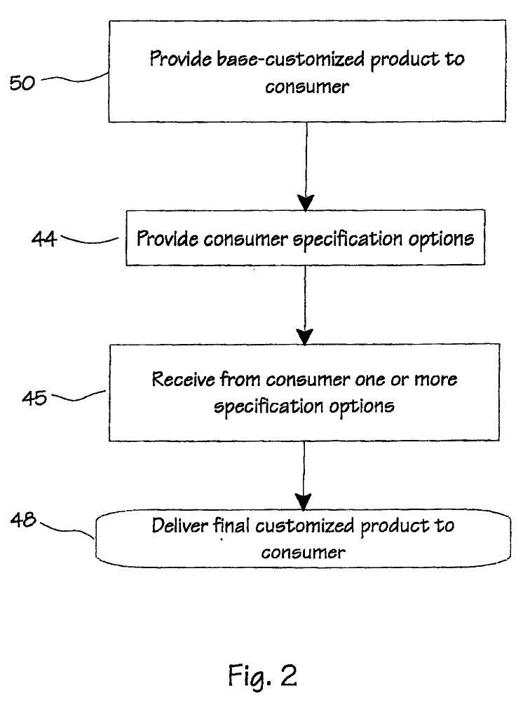

FIG. 2 illustrates further aspects of a specific embodiment of the present invention which shows additional steps for providing a customized product combination of FIG. 1. The method further comprises providing the consumer specification options (44) for the base-customized product. Instructions from the consumer are received (45) with respect to the one or more specification options for the customized product. Illustrative specification options for the cosmetic product example comprise color of the product, scent of the product, scent level of the product, texture of the product, addition of glitter or similar additive to the product, addition of micro beads to the product, or addition of one or more supplements to the products. Supplements might include biobotanicals, beta hydroxy products, organic products, vitamins and minerals. One skilled in the art will appreciate that other known specification options and additives may be added to the customized product. The final customized product is then delivered (48) to the consumer. Delivery may comprise immediately presenting the completed product to the customer, such as in a store or at a kiosk or customer service window, shipping the product to the consumer, mailing the product, having the consumer pick up the product, or any other method of product delivery known to one skilled in the art.

It should be noted that, while many of the examples herein are set forth in an exemplary context of cosmetic products, the present invention is contemplated as being equally applicable to any of a variety of products and services. As used herein, the term “specification” shall connote the combination of elements, features and/or characteristics of a product which may be modified to customize the product to particular performance or preference choices of the consumer.

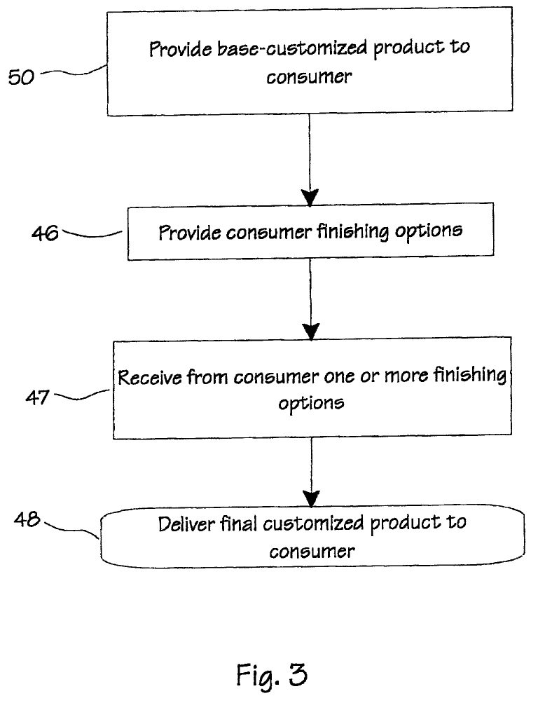

Further aspects of a specific embodiment of the present invention are depicted in FIG. 3, which shows the additional steps for providing a customized product combination of FIG. 1, comprising providing the consumer one or more finishing options (46) for the selected base-customized product. Exemplary finishing options for the cosmetic product example would include choice of packaging of the customized product, choice of product labeling options and choice of product wrapping options. More preferred finishing options might include choice of package shape, size, color and functionality. Preferably the choice of functionality would itself comprise the choice of dispensing devices, such as squeeze tube or pump. In addition, preferred examples of labeling options comprise selection of label shape, color, design and text. Specific embodiments of the product wrapping options might comprise selection of design, selection of wrap color and material. One skilled in the art will appreciate that other known finishing options and additives may be added to the customized product.

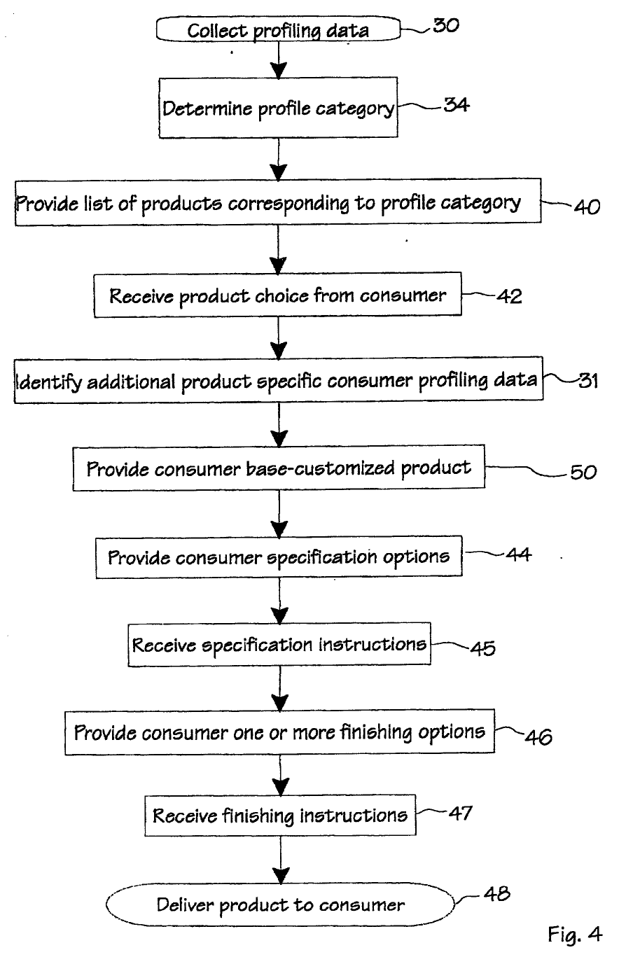

Another specific embodiment of a method according to the present invention is depicted in FIG. 4, wherein consumer profiling data is collected (30) from the consumer as discussed above. Consumer profiling data may be collected through a user interface, direct interaction over a telephone, in-person consultations, E-mail, handwritten questionnaires, test kits, etc. Preferably, the consumer completes a survey and/or utilizes and submits results from a test kit which contains questions and tests which yield consumer profiling data. Preferably, the consumer is at least initially presented an electronic survey at a user interface. The consumer profiling data comprises psychological, physiological and attitudinal information about the consumer. Preferred consumer psychological and attitudinal information comprises personality information, visual preferences, expectation information, etc. This consumer profiling data is analyzed and a consumer profile category is determined (34). To determine the consumer profiling category, the consumer's responses to the profiling data inquiries are matched against a decision tree. The decision tree comprises potential combinations of the consumer responses to the consumer profiling inquiries. Preferably, the decision trees are converted to mathematical algorithms which process the decision trees electronically to ascertain the appropriate category to assign the consumer. The decision trees for initial category profiles preferably are based on historical consumer research models and data for consumers having similar factors. The consumer may be assigned various profile sub-categories which correspond to specific product categories (such as hair care, skin care, cosmetics, fragrances, etc.). More preferably, a neural network determines which consumer profile category to assign the consumer. The neural net assesses feedback data from the consumer to determine if any changes to the mathematical algorithms or new product categories are needed to meet the needs of the consumer. For example, a neural network can continuously update its decision making algorithm by incorporating consumer feedback, purchasing trends, and demographic information into the decision making process. According to Haykin, S. (1994), Neural Networks: A Comprehensive Foundation, NY: Macmillan, p. 2, a neural network is a massively parallel distributed processor that has a natural propensity for storing experiential knowledge and making it available for use. It resembles the brain in two respects: 1) Knowledge is acquired by the network through a learning process. 2) Interneuron connection strengths known as synaptic weights are used to store the knowledge. The neural network analyzes product trends, feedback data, demographic data and other additional data to develop and refine algorithms for decision making. In a specific embodiment, the neural network automatically makes changes to the customized user interface and decision making algorithms.

The consumer is provided a list of products (40) which correspond to the consumer profile category of the consumer. Preferably, the list of products which correspond to a specific consumer profile category are stored in a data repository. The list of products corresponds to a specific profile category or sub-category. Preferably, the list of products is based on historical consumer profiling models and data. More preferably, the list of products corresponds to the consumer's physiological conditions, lifestyle, life stage and desired look. The product choice of the consumer (42) is received from the list of products. The product choice indicates which product the consumer would like to customize. Additional consumer profiling data is identified (31) to customize the selected product to meet the consumer's physiological conditions and external conditions (such as water hardness, etc.). Preferably, the consumer is presented questions which elicit the additional consumer profiling data. The questions may be preferable stored in a data repository and the consumer's responses are stored in the consumer's profile category in the data repository. The consumer is then presented on the user interface a base-customized product (50) which corresponds to the additional consumer profiling data and the selected product choice. In a specific embodiment, the consumer can then choose to purchase the product or choose to further customize the product. If the choice is to purchase at that time, details of the product packaging, labeling and dispensing options can be determined by default to a predetermined combination and/or in accordance with prior obtained consumer profiling data.

If the consumer chooses to further customize the product, the consumer is provided one or more specification options (44) for the customized product. Instructions from the consumer are received (45) with respect to the one or more specification options for the customized product. Preferred specification options for our cosmetic example can comprise color of the product, scent of the product, scent level of the product, addition of glitter or similar additive to the product, addition of micro beads to the product, or addition of one or more supplements to the products. Preferred supplements include biobotanicals, organic products, vitamins and minerals. One skilled in the art will appreciate that other known specification options and additives may be added to the customized product.

The consumer is thereby provided one or more finishing options (46) for the customized product. Instructions are received (47) from the consumer with respect to the one or more finishing options. Preferred finishing options for the cosmetic application might include choice of packaging of the customized product, choice of product labeling options and choice of product wrapping options. More preferred finishing options include choice of package shape, size, color and functionality. Preferably, the choice of functionality further comprises the choice of dispensing devices, such as a squeeze tube or a pump. In addition, specific embodiments of labeling options comprise selection of label shape, color, design and text. While some text, such as contents and other information required by applicable laws might be included on all products, other elements can be options (such as font size, font type and color, etc.). Specific embodiments of the product wrapping options comprise selection of design, selection of wrap color and materials of construction. One skilled in the art will appreciate that other known finishing options and additives may be added to the customized product.

In another specific embodiment of the present invention, the collection of profiling data about a consumer comprises providing the consumer a test kit. In the application of the invention for cosmetic products, for example, the test kit might comprise one or more tests to determine physiological conditions of the consumer such as skin dryness, skin oiliness, hair dryness, hair oiliness, brittleness of hair and color complexion of the consumer. Preferably, such a test kit would also comprises additional environmental tests (such as water hardness, water pH, etc.) which effect the performance of personal care products. In one specific embodiment of the invention for cosmetic products, the test kit is delivered to the consumer and the consumer then provides the results and input from such test through the user interface. Preferably, the consumer enters the results electronically or provides the results through voice communication, for example over the telephone. Alternatively, the consumer might receive the test kit at a central location, where all or a portion of the tests are completed. In addition, the test kit may be personally delivered to the consumer and the tests performed by trained specialists. In yet another specific embodiment, the consumer might submit one or more items from the test kit to a testing center for analysis. Preferred analysis to be completed by the testing center for such an application might comprise skin dryness, skin oiliness, hair dryness, hair porosity, hair oiliness, and skin tone color matching.

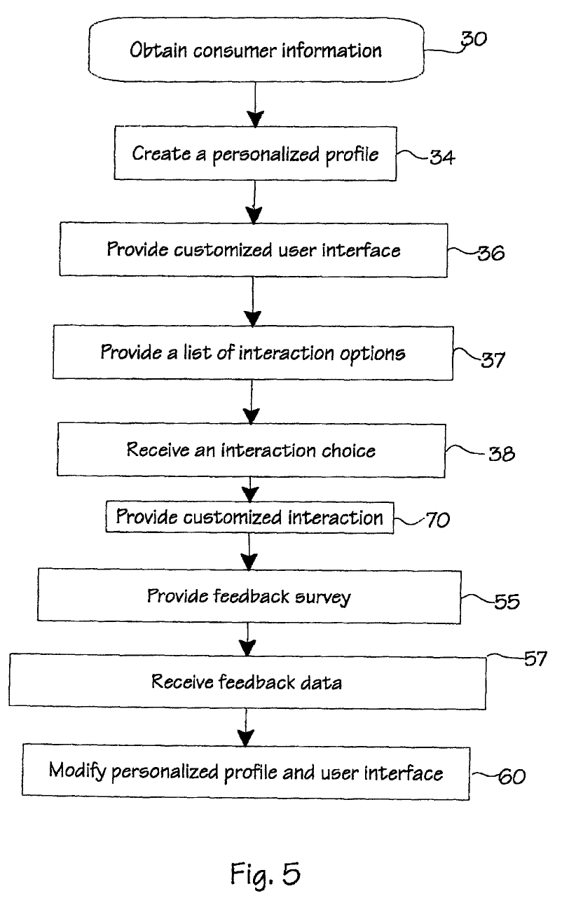

Another embodiment of the present invention is a method for a personalized product-related service as depicted in FIG. 5. This method creates a personalized shopping experience for the consumer. First, personal information about the consumer is obtained (30). Preferably, this information comprises psychological and physiological information about the consumer, such as preferred colors and styles, lifestyle, life stage, attitude, desired look of hair, desired look of face, skin type, skin condition, hair type, hair condition, fashion style and level of involvement. Preferably, the level of involvement comprises the number of products the consumer may use to achieve a desire outcome and the amount of time the consumer will spend to achieve the desired outcome. A personalized profile is created (34) from this personalized information. The consumer is then provided with a unique and customized user interface (36) with customized information pages based at least in part on the personalized information and profile. Every option presented to the consumer can then be appropriately customized to correspond to the consumer's personalized profile. Customizable options include imagery, tone, design of text, name personalization, general lifestyle information, beauty care information, etc. The user interface also preferably provides the consumer with a list of interaction options (37) that correspond to the personalized profile. Preferably, the list of interaction options is stored in the data repository and corresponds to a specific profile category or sub-category. Preferably, the list of interaction options corresponds to the consumer's physiological conditions, lifestyle, life stage and desired look. An interaction choice is received from the consumer (38) and a customized interaction is provided to the consumer (70). Upon completion of interacting with the selected interaction choice, the consumer is provided a consumer feedback survey (55), which might be in the form of multiple choice inquiries derived from a data repository of further personalized information categories and preferences stored in the computer. Preferably, feedback questions are designed to optimize the customization of the interaction and satisfaction of the consumer. Feedback information is collected both voluntarily and prompted. Preferably, every interaction is followed by feedback data which is then utilized to learn the consumer's preferences and optimize the consumer's experience. As an example, the survey might comprise questions about recent purchases of customized products. The questions might comprise questions on how the consumer liked the product, any problems encountered using the product, overall satisfaction for the product, and possible ways to improve the product. For example, in a hair care product model, the feedback survey may comprise questions inquiring whether the shampoo had too much or too little lather, whether the cleaning level was satisfactory, and whether the shampoo delivered the desired effectiveness The feedback data in the survey is received from the consumer (57). Preferably, this feedback data is used to make modifications or suggestions for modifications to the personalized profile of the consumer and the customized user interface (60). Preferably, this feedback data comprises performance and aesthetic attributes for the product. The feedback data preferably is used by human analysis to determine modifications to the consumer profile and to recommend addition customized products. In a more specific embodiment, the feedback analysis will be conducted by a mathematical algorithm and/or decision trees. Preferably, if the feedback comprises a neutral or negative response from the consumer, additional product feedback information will be gathered from the consumer and possible alternative products will be recommended to the consumer. In a specific embodiment, the interaction options (37) provided to the consumer comprise a predetermined list of products available for the consumer to customize. The available products can be updated and modified at any time and will periodically be improved and supplemented with new or additional choices. The customizable products correspond to the personalized profile of the consumer. Preferably, after the consumer selects one of the products, the consumer is provided with one or more specification options for the selected product. Preferably, the consumer is also provided with one or more finishing options for the selected product. The finishing options for the selected product are preferably stored in a data repository. The user interface retrieves the corresponding options from the data repository for the selected product.

Often computers telecommunicate with each other and share information, applications and/or services. Sometimes in this setting, the various computers are referred to as nodes, which is a generic term referring to a point in a interconnected system. One type of computer network employs a client/server architecture, wherein the portions of network applications that interact with human users are typically separated from the portions of network applications that process requests and information. Often, the portions of an application that interact with users or access network resources are called client applications or client software, and portions of an application that process requests and information are called server applications or server software. Client machines tend to run client software and server machines tend to run server software, however a server can be a “client” as well. In a specific embodiment of the invention, the consumer's user interface is on a client machine and the software containing the computer instructions which comprise the methods according to the present invention is located on a server computer.

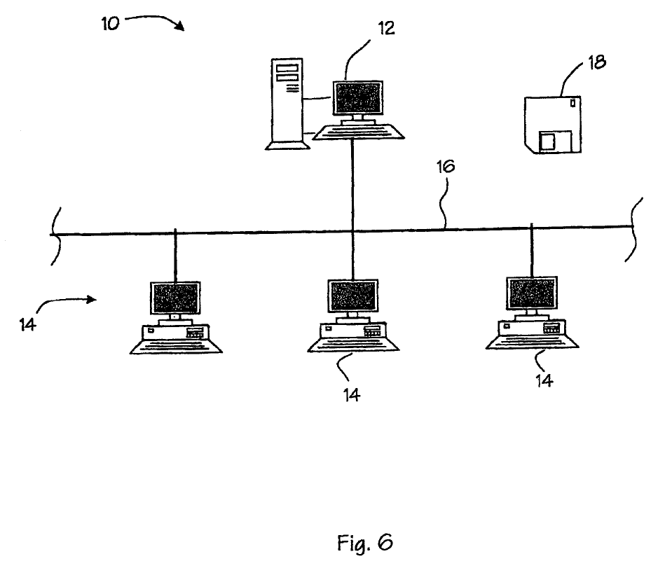

FIG. 6 illustrates a sample client/server network 10. As one with ordinary skill in the art will readily appreciate, a client/server network is only one type of network, and a variety of other configurations, such as peer-to-peer connections, are also considered networks. In a client/server network, a plurality of nodes are interconnected such that the various nodes send and/or receive information to/from one another. As shown here, a server node (12) is interconnected to a plurality of client nodes (14) using a connection (16) such as a token ring, Ethernet, telephone modem connection, radio or microwave connection, or the like.

A computer-readable medium, shown here as a floppy diskette (18), holds information readable by a computer, such as programs, data, files, etc. As one with ordinary skill in the art will readily appreciate, computer-readable medium can take a variety of forms, including magnetic storage (such as hard disk drives, floppy diskettes, etc.), optical storage (such as laser discs, compact discs, etc.), electronic storage (such as random access memory “RAM”, read only memory “ROM”, programmable read only memory “PROM”, etc.), and the like. Some types of computer readable medium, which are sometimes described as being nonvolatile, can retain data in the absence of power so that the information is available when power is restored.

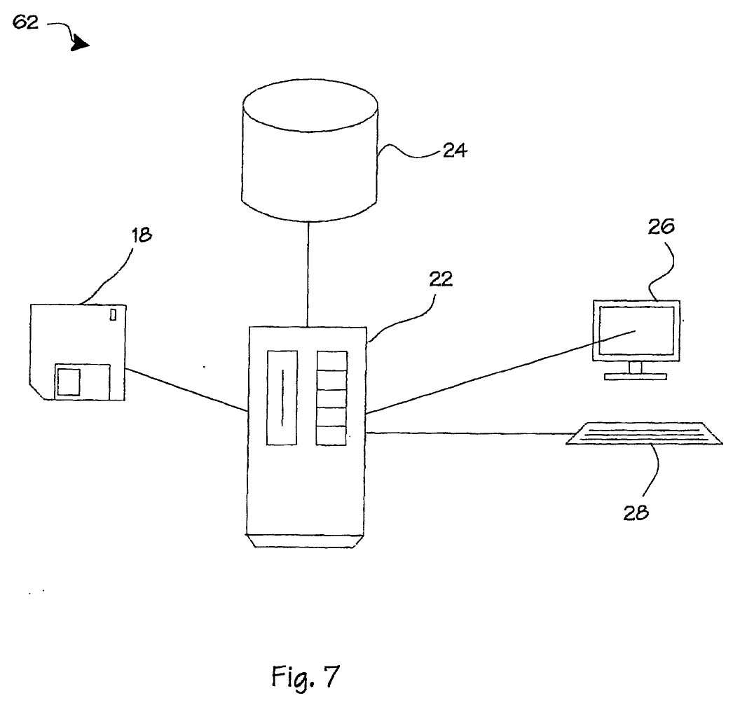

Another embodiment of the present invention might comprise an apparatus for providing customized products to a consumer as schematically depicted in FIG. 7. The apparatus (62) comprises a data repository (24) storing one or more consumer profiles; an input device (28) for receiving user input from a consumer; a computer assembly (22) comprising a CPU and memory, wherein the computer assembly (22) is connected to the data repository (24) and the input device (28); a computer-readable storage medium (18) containing computer executable instructions for the computer assembly (22); and a display means (26) for visually interacting with a consumer, such as for displaying suggested products which can be selected and customized by the consumer. Preferably, the computer assembly (22) is a general purpose computer. Preferably, the display means (26) is a computer monitor, video display terminal, or other appropriate display device. Preferably, the data repository (24) includes a relational database system or a distributed directory such as Novell Directory Services (NDS). A relational database management system (RDBMS) is a computer database management system that uses relational techniques for storing and retrieving data. Relational databases are computerized information storage and retrieval systems in which data in the form of tables are typically stored for use on disk drives or similar mass data stores. A “table” includes a set of rows spanning several columns. Each column in a table includes “restrictions” on the data contents thereof and may be designated as a primary or foreign key. Reference is made to C. J. Date, An Introduction to Database Systems, 6th edition, Addison-Wesley Publishing Co. Reading, Mass. (1994) for an comprehensive general treatment of the relational database art. An RDBMS is structured to accept commands to store, retrieve and delete data using high-level query languages such as the Structured Query Language (SQL). The term “query” denominates a set of commands for retrieving data from a stored database. The SQL standard has been promulgated by the International Standards Association since 1986. Reference is made to the SQL-92 standard “Database Language SQL” published by the ANSI as ANSI X3.135-1992 and published by the ISO as ISO/IEC 9075:1992 for the official specification of the 1992 version of the Structured Query Language. Reference is also made to James R. Groff et al. (LAN Times guide to SQL, Osborne McGraw-Hill, Berkeley, Calif., 1994) for a lucid treatment of SQL-92.

In a specific embodiment, the input device (28) would comprise a keypad, keyboard, or similar input means to allow a consumer to input information and respond to interactive communications. In another embodiment, the input device would comprise a microphone with voice recognition software. This embodiment would allow those with certain physical limitations or disabilities to interact with the user interface. More preferably, the input device (28) comprises a keyboard on a computer in electronic communication with the computer assembly (22). In another specific embodiment of the present invention, the input device (28) is associated with a user kiosk or a service window or module. A kiosk is a small, self-standing structure such as a newsstand or ticket booth, while service windows and modules are intended to include drive up, walk up, or other customer service accommodations which may be self-standing or associated with other related or unrelated places of business (for example department stores, waiting rooms of doctor's offices, etc.). Unattended multimedia kiosks typically dispense public information via computer screens or other user interface media. Either a keyboard, touch screen, voice recognition and/or a combination of each are typically used for input. Preferably, the input device (28) is associated with an electronic communication device for accessing the computer assembly (22). In a specific embodiment, the input device (28) further comprises a touch tone telephone which allows the consumer to order products through a touch tone ordering system.

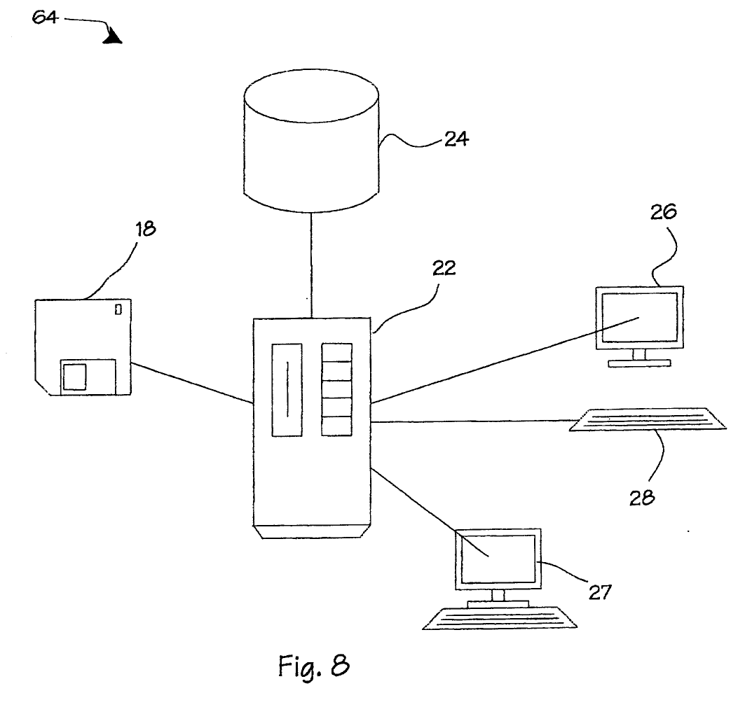

In another specific embodiment (system 64 of FIG. 8), the apparatus further comprises a communication node (27), which can be located at a point of manufacturing of the products to provide quick and optimal communication of product formulation and finishing options from the consumer to the manufacturing location. The communication node preferably comprises an additional input device and display device. Preferably, a customer service representative interacts with the consumer through the communication node (27).

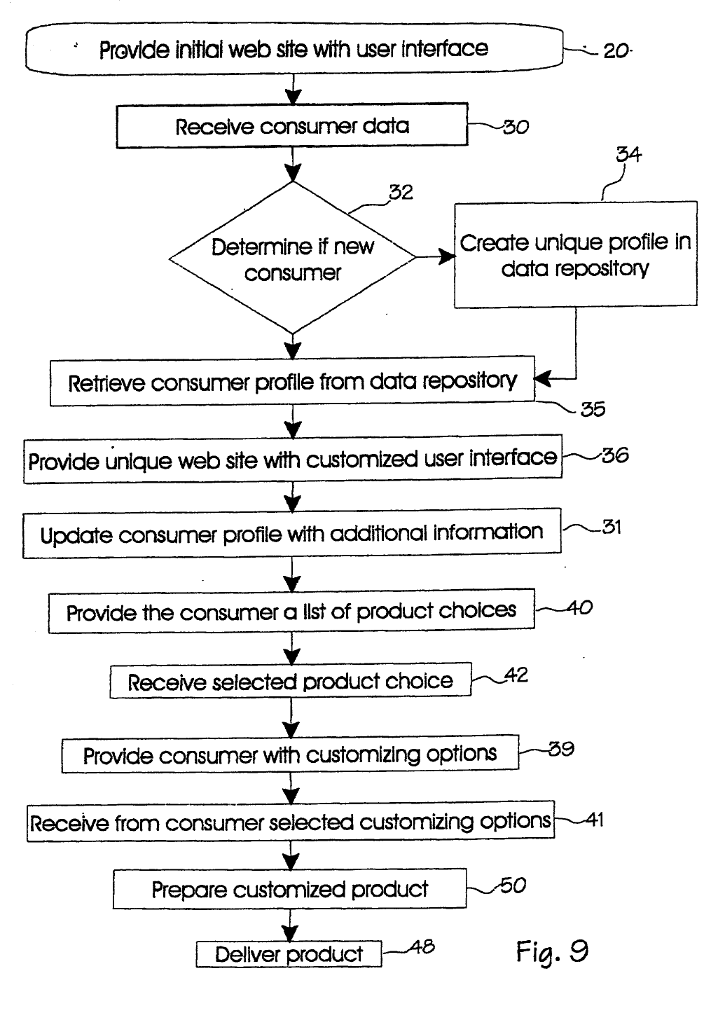

Another embodiment of the present invention is depicted in FIG. 9, where a network-based method for providing a customized product combination to a consumer is illustrated. The method comprises the steps of providing a web site having a user interface (20), wherein the user interface includes consumer identification data. One or more items of consumer information are received (30) at the user interface from a consumer, and an analysis is conducted (32) to determine whether the consumer is a new user to the user interface. A unique consumer profile is then created (34) and stored in a data repository for the consumer, if the consumer a new to the user interface. That unique consumer profile is then available to be accessed (35) from a data repository upon input of the consumer identification data of the consumer. During the first session, the unique consumer profile would be created and then used for that initial session. A unique web site having a customized user interface corresponding to the consumer profile for the consumer is preferably provided (36), and the consumer profile in the data repository is updated (31) with additional profile information. Preferably, the consumer profile is continually updated during the consumer's interactions with the customized user interface. A list of recommended product choices which correspond to the updated consumer profile is then provided (40) to the consumer. The list of recommended product choices is compiled by a retrieving from a data repository, a list of predetermined product choices corresponding to the particular product category. A selected product choice from the list is thereafter received (42) from the consumer once he or she considers the products listed. The consumer is thereafter provided with one or more customizing options (39) for the selected product. The customizing options are stored in a data repository. The data repository stores each customizing option available for each product available to consumers. Each of the customizing options will have one or more choices for the particular customizing option. One or more selected customizing options are received (41) from the consumer. The selected product is then prepared (50) with the chosen customized options and the customized product is thereafter delivered (48) to the consumer. In a specific embodiment, the customization option provided to the consumer (39) comprises specification options (44) and finishing options (46). These specification and finishing options are retrieved from a data repository wherein the specification and finishing options for the specific product are stored.

One specific embodiment of the present invention is a customized user interface for providing a customized product combination. An example of this is a web server and a web browser on the Internet. The Internet and World Wide Web operate on a client/server model. The consumer runs a web client, or browser, on a electronic device such as a computer or television tuner. The web browser contacts a web server and requests data information, in the form of a Uniform Resource Locator (URL). This data information comprises the customized user interface comprising the customizable product choices which correspond to the consumer. URLs are typed into the browser to access web pages, and URLs are embedded within the pages themselves to provide the hypertext links to other pages. Many browsers exist for accessing the Web. Examples of browsers include the Netscape Navigator from Netscape Communication Corp. and the Internet Explorer from Microsoft Corp. Numerous web servers exist for providing content to the World Wide Web. Examples of servers include Apache from the Apache Group, Internet Information Server from Microsoft Corp., Lotus Domino Go Webserver from IBM, Netscape Enterprise Server from Netscape Communications Corp., Oracle Web Application Server from Oracle Corp. and Red Hat Linux from Red Hat Corp.

Consumer input is received through the user interface and is then received at the web server. The web server then interprets the consumer input and delivers to the consumer corresponding web pages. In a specific embodiment, the web server may push the consumer input over to another analysis device such as a neural net to process the consumer input.

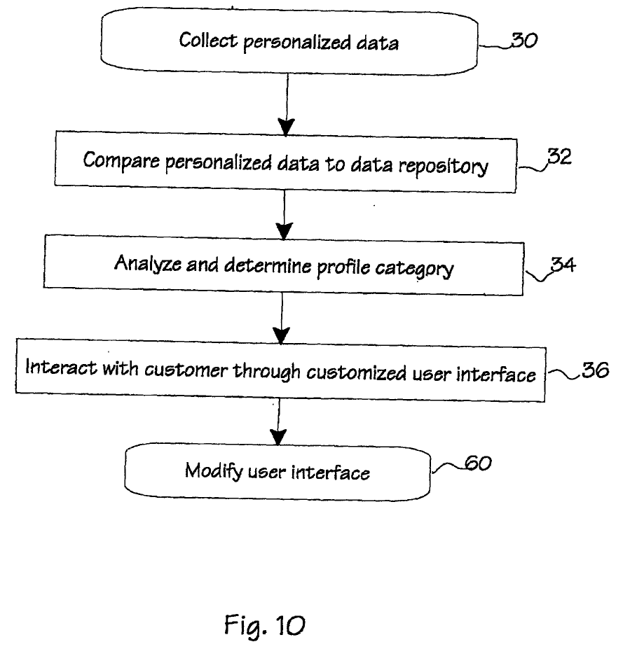

Another embodiment of the present invention includes a method suitable for use in electronic shopping for providing customized product-related services to a consumer as depicted in FIG. 10. Personalized data about the consumer is collected (30) in a manner similar to that described above. Preferably, the personalized data pertains to at least one of the pre-defined profile categories. The personalized data is compared (32) to other personalized data in the data repository to determine if the consumer has an assigned or established profile in the system. Preferably, at least a portion of the personalized data comprises a username and password. The username and password are compared with usernames and passwords in the data repository to determine if there is a match. If a match is found, the corresponding profile for the consumer will be retrieved from the data repository. The collected data pertaining to the consumer is then analyzed and a pre-defined profile is selected (34) from the profile categories in the data repository. The selected profile is transparent (i.e., not revealed) to the consumer, however, as that categorization is only utilized internally to the system. A customized user interface is then provided through which the consumer interacts (36), and that the user interface is preferably customized for the consumer based upon the selected profile. The consumer is then provided with a unique and customized user interface (36) with customized information pages based at least in part on the personalized information and profile. Every option presented to the consumer can then be appropriately customized to correspond to the consumer's personalized profile. Customizable options include imagery, tone, design of text, name personalization, general lifestyle information, beauty care information, etc. The user interface also preferably provides the consumer with a list of interaction options that correspond to the personalized profile. Preferably, the list of interaction options is stored in the data repository and corresponds to a specific profile category or sub-category. More preferably, the list of interaction options corresponds to the consumer's physiological conditions, lifestyle, life stage and desired look. Preferably, the user interface is periodically modified (60) for the particular consumer based upon personalized data supplied by the consumer, purchasing choices made by the consumer, demographic data, feedback data, and/or a combination thereof.

Another embodiment of the present invention comprises a computer-readable storage medium containing computer executable code for instructing a computer to perform the following steps: collecting consumer profiling data about a consumer; determining a consumer profile category corresponding to the consumer profiling data; providing the consumer a list of one or more products that correspond to the consumer profile; receiving from the consumer a product choice selected from the list; identifying additional consumer profiling data from the consumer which corresponds to the selected product choice; and providing the consumer a customized product corresponding to the additional consumer profiling data and the selected product choice. In a specific embodiment of the present invention, the computer-readable storage medium further comprises computer executable code for instructing a computer or similar functional device to perform the following additional steps: providing the consumer one or more specification options for the customized product; and receiving from the consumer instructions with respect to the one or more specification options for the customized product. The computer-readable storage medium might further preferably comprise instructions to perform the following additional steps: providing the consumer one or more finishing options for the customized product; and receiving from the consumer instructions with respect to the one or more finishing options for the customized product. As detailed above, in this way, additional features and characteristics of the products, services, labeling and packaging can be individualized for the consumer.

In another embodiment of the present invention, a computer-readable storage medium comprises computer executable code for instructing a computer to perform the following steps: providing a web site having a user interface, wherein the user interface requests consumer identification data; receiving at the user interface one or more items of consumer identification data from a consumer; determining if the consumer is a new user to the user interface; creating a unique consumer profile in a data repository for the consumer, if the consumer is a new user; accessing from a data repository the unique consumer profile corresponding to the consumer identification data of the consumer; providing a unique web site having a customized user interface for the consumer according to the consumer profile; periodically updating the consumer profile in the data repository with additional profile information; providing to the consumer a list of recommended product choices corresponding to the updated consumer profile; receiving from the consumer a selected product choice; providing the consumer with one or more customizing options for the selected product; receiving from the consumer one or more selected customizing options; preparing the selected product with the customizing options for the consumer; and delivering the customized product to the consumer. In a specific embodiment, the customizing options also comprise specification options and finishing options, as discussed above.

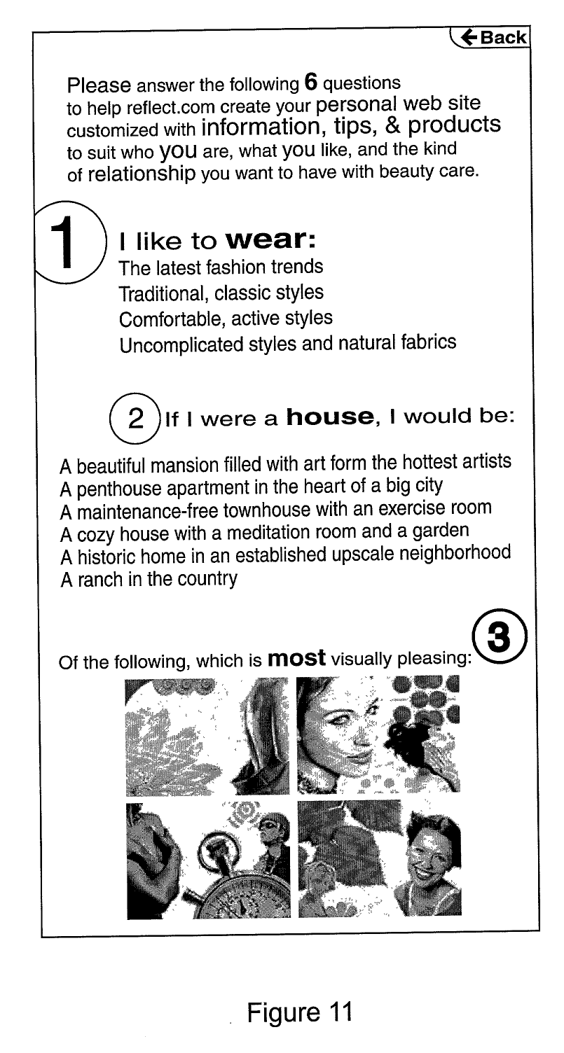

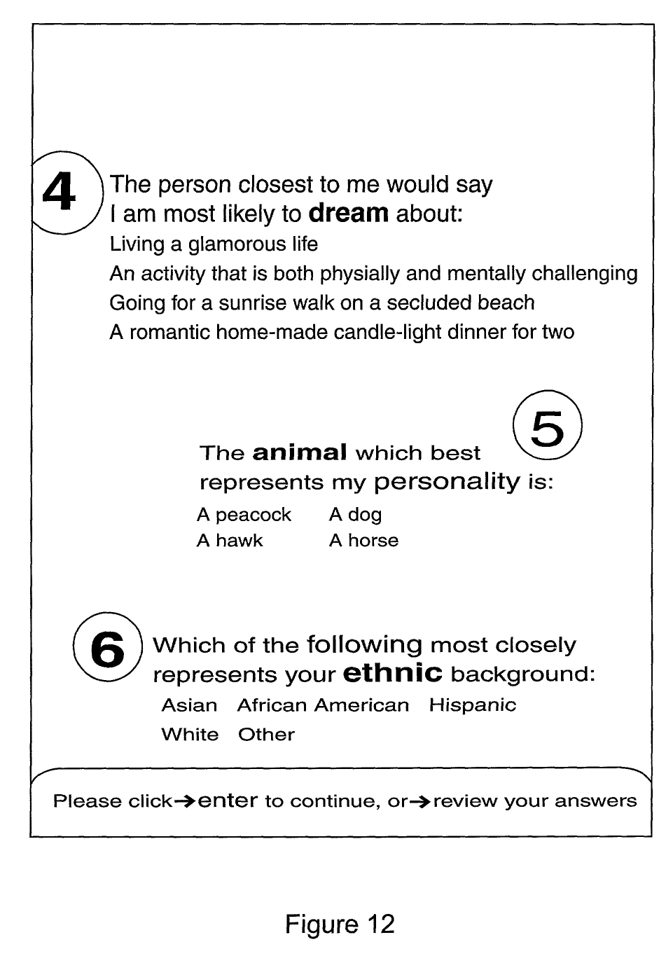

In our example of a specific embodiment of the present invention for application in the cosmetics or beauty care field, a consumer accesses a web site for customized beauty care products. The web server determines if this particular customer has previously registered as a user or if the particular consumer is a new user to the web site. If the consumer is a new user, the web server delivers web pages to the consumer's web browser requesting registration information from the consumer. Preferably, this registration information comprises at least the consumer's name, address and a unique username and password. The username and password may be chosen by the consumer or the web server. The registration information also comprises consumer profiling information, which might include physiological and psychological information about the consumer and preferences. FIGS. 11 and 12 depict exemplary embodiments of web pages containing inquiries for eliciting such consumer profiling information. According to an alternate embodiment, the new user may engage in product customization as a guest visitor to the site, i.e., without registering, before providing any personal information.

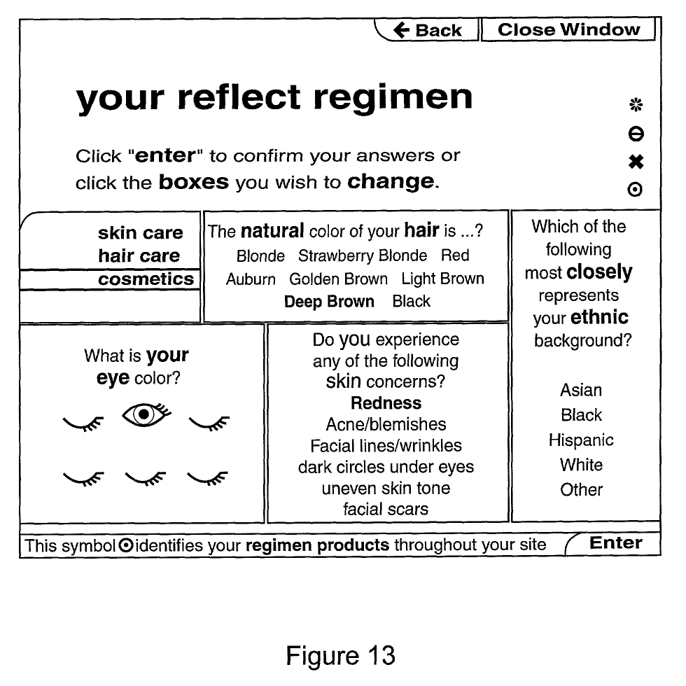

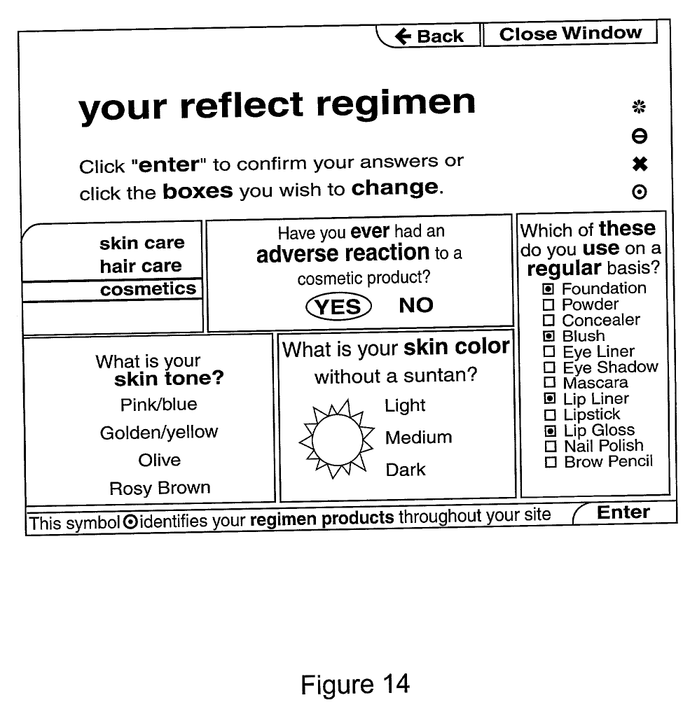

Once the web server has received the appropriate consumer profiling information, the web server determines a consumer profile category to assign the consumer. To determine the consumer profiling category, the consumer's responses to the profiling data inquiries are matched against a decision tree. The decision tree comprises potential combinations of the consumer responses to the consumer profiling information. Preferably, the decision tress are converted to mathematical algorithms which process the decision trees electronically to ascertain the appropriate category to assign the consumer. The decision trees for initial category profiles preferably are based on historical consumer research data for consumers having similar factors. The consumer may be assigned various profile sub-categories which correspond to specific product categories (such as hair care, skin care, cosmetics, fragrances, etc.). This consumer profile category is customized to correspond to the consumer's profiling data. It is contemplated that the profile category can be a set of internal categorizing parameters or guides which are utilized in the system to identify lists of products, services and/or features and options thereof which will be suggested or offered to the consumer as appropriate during a transaction or shopping event. As this categorization is highly proprietary to the system, subject to continual updating and change based on products or service changes, updates, enhancements, and/or on changing needs or preferences of the consumer, it is preferably maintained as “transparent” to the user, and is provided only indirectly via a customized web site tailored to the consumer profiling data and product or service correspondence determined by the system. The web site provides the consumer a list of individualized interaction options from which the consumer may choose. Exemplary interaction options for beauty care products might include customization of skin care, hair care, cosmetic and fragrance products. When the consumer selects an interaction option, the web server delivers further customized web pages to the consumer corresponding to the selected interaction option. When the consumer selects an interaction option which comprises customized products, the web server determines if the consumer has created a personalized profile specific to the selected product option. Preferably, the personalized profile contains physiological (for example skin dryness, skin concerns such as acne or pimples, hair color, eye color, skin tone, skin sensitivity, etc.) and additional psychological information (for example color preferences, degree of involvement such as number of products and time spent using products, etc.) about the consumer. FIGS. 13 and 14 depict illustrations of exemplary web pages comprising a personalized profile for cosmetic products. Preferably, the personalized profile is customized for the consumer's profile category. When the consumer has completed the personalized profile, the web server determines which types of cosmetic products would match the consumer's personalized profile.

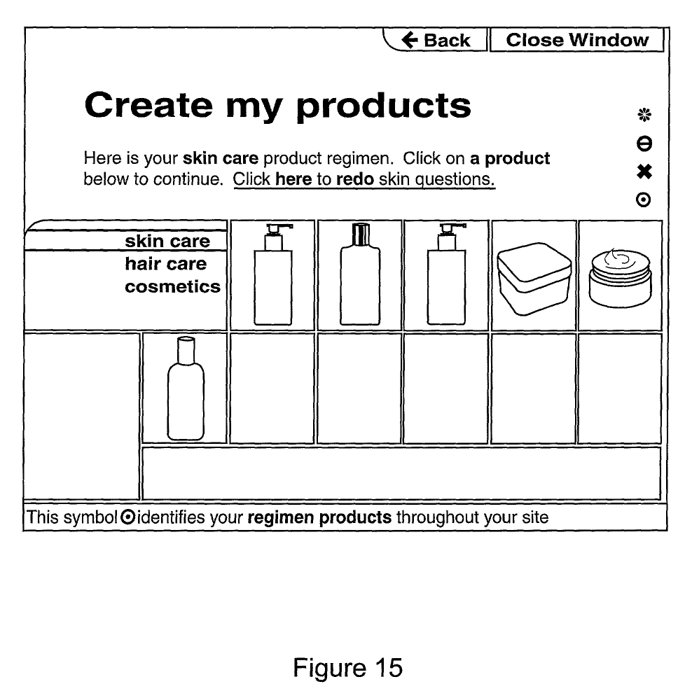

The consumer is then provided with a list of products or services which match the consumer's personalized profile. FIG. 15 depicts a illustration of a specific example of a web page listing the products which match a particular consumer's personalized profile. Preferably, the list of products will indicate if the product requires (or has available) further customization before the product can be purchased. In FIG. 15, the product image is out of focus and fuzzy, which indicates to the consumer that the product is not ready to be purchased. In another specific embodiment, the user interface may comprise audio interaction and response. Preferably, the consumer interacts with the user interface through a microphone and speakers. This embodiment is particularly beneficial to consumers who have difficulty utilizing other input devices or have difficulty reading from the user interface. In another embodiment of the present invention, an image of the consumer is displayed and the consumer can make product selections and the virtual results are displayed on the image of the consumer. Preferably, the user interface will depict how the products will look on the consumer to help define the consumers preferred look. In another embodiment, the consumer alters the image to produce the desired look and then is provided with a list of products which should achieve the desired look. Preferably, this list is determined by a mathematical algorithm which yields one or more corresponding profile categories.

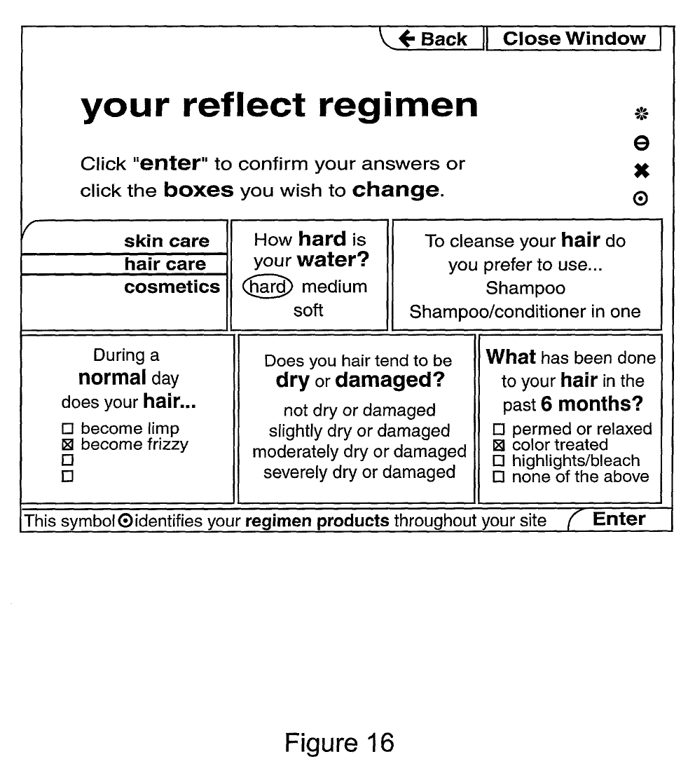

When the consumer selects a product to customize, the web server receives the request from the consumer and determines whether the consumer has completed a personalized profile for the selected product. Preferably, the personalized profile for the selected product comprises additional physiological and environmental data which aids in the completion of the customization of the selected product. If the consumer has not completed a personalized profile for the selected product, the web server solicits additional information such as by providing the consumer with a survey or questionnaire requesting additional information to aid in customizing the product and/or to identify preferences. FIG. 16 depicts an example of a questionnaire for additional information to customize a hair shampoo product.

When the consumer has submitted the additional personalized data requested, the web server determines the proper formulation and/or elements for the selected product. Preferably, this product combination is customized to correspond to the consumer's physiological and environmental conditions. In another specific embodiment, the specifications for the selected product is delivered to a manufacturing facility, where the customized product is manufactured and packaged. In yet another specific embodiment, a computer determines if the customized product specification matches any pre-defined versions of the selected product. If the computer determines that a specific version matches the customized formulation for the selected product, the matching version of the product is provided to the consumer. Preferably, the product is free of any proprietary identifications as to formulation or version of the product. In a specific embodiment, if a pre-existing version does not exist which matches the consumer's needs and desires, a new version of the product will be created to match the consumer's needs and desires.

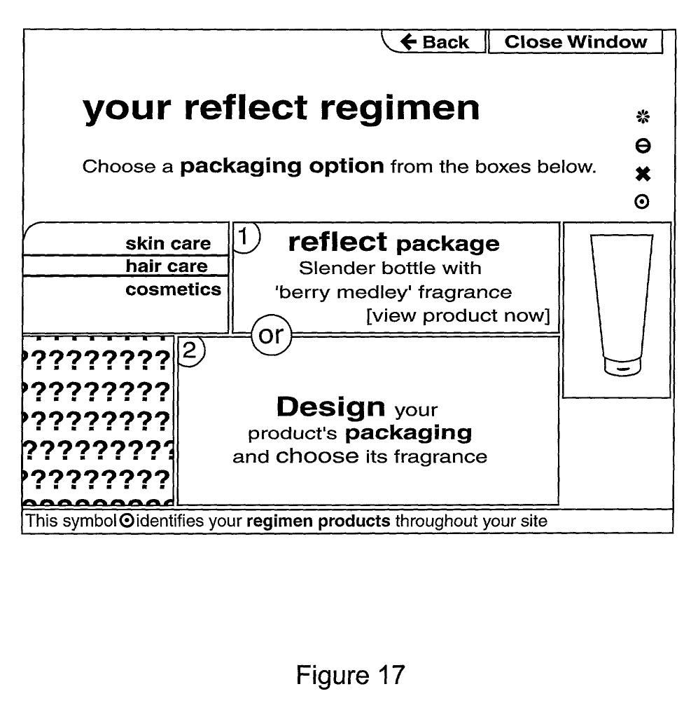

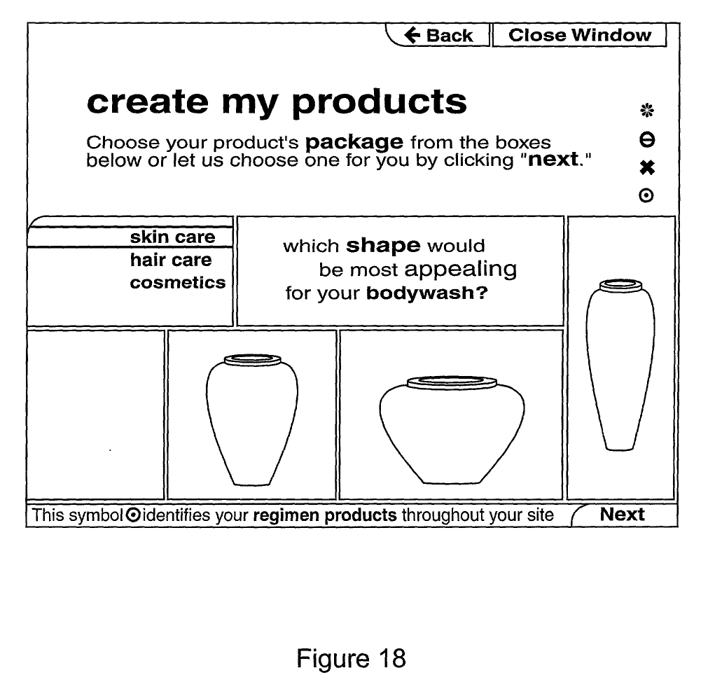

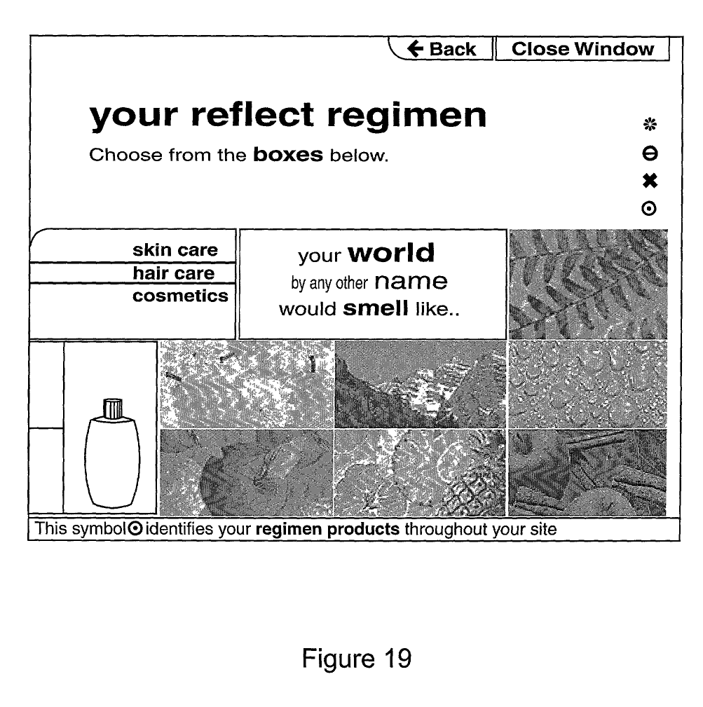

Once the product itself has been specified, the consumer is given the option to purchase the customized product or to further customize the product with specification and finishing options. FIG. 17 depicts an illustration of and an exemplary web page providing the consumer a choice of purchasing the customized product or the option of further customizing the product. Preferably, the customization options comprise both specification and finishing options. Preferred specification options for our cosmetic example can comprise color of the product, scent of the product, scent level of the product, addition of glitter or similar additive to the product, addition of micro beads to the product, or addition of one or more supplements to the products. Preferred supplements include biobotanicals, organic products, vitamins and minerals. One skilled in the art will appreciate that other known specification options and additives may be added to the customized product. Preferred finishing options comprise package shape and functionality, labeling options and product wrapping options. FIGS. 18 and 19 depict illustrations of additional exemplary web pages comprising customizing options for a hair shampoo product. When the consumer has finished customizing the product, the consumer is given the opportunity to purchase the product. The product is the provided to the consumer. Preferred methods of delivery include mail, overnight delivery, consumer pick-up, hand delivery, or consumer pick-up of the product at a retail environment such as a beauty salon or spa.

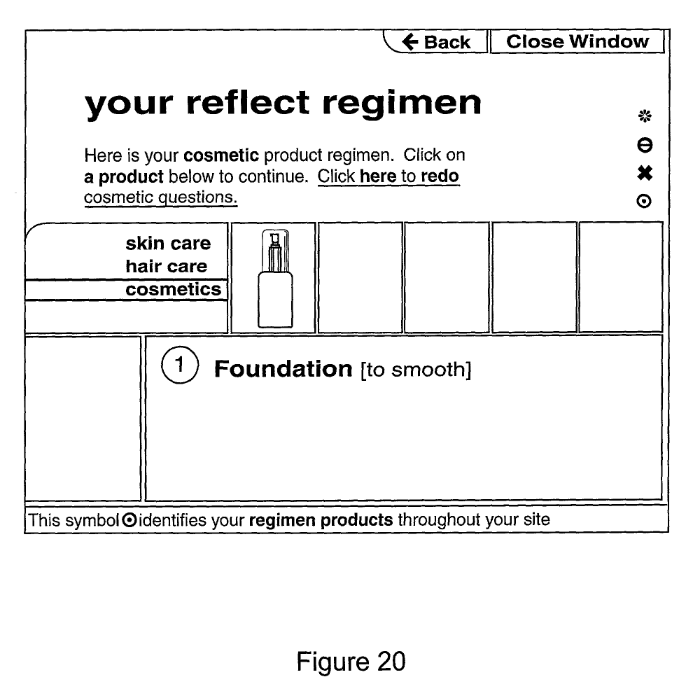

On subsequent interactions with the consumer, the web pages preferably indicate which products have been previously customized by the consumer and are ready to purchase. As discussed, the user interface may indicate which products are available for purchase and which products are currently not available or ready for purchase. In a specific embodiment, one or more products may be available for immediate purchase and not require customization. FIG. 15 depicts an illustration of an example of a web page indicating that the selected product requires further customization, whereas, FIG. 20 depicts and an illustration of a similar web page indicating that the customized product is available for immediate purchase.

After a customized product has been provided to the consumer, feedback data is requested from the consumer. For example, the various ways of requesting feedback data might comprise inquiries via voice communication, direct mail, electronic mail and additional web pages requesting feedback on the web site. The feedback data is preferably processed by a neural network. In a specific embodiment, the neural network suggests changes to the consumer profiling algorithms and customized user interface.

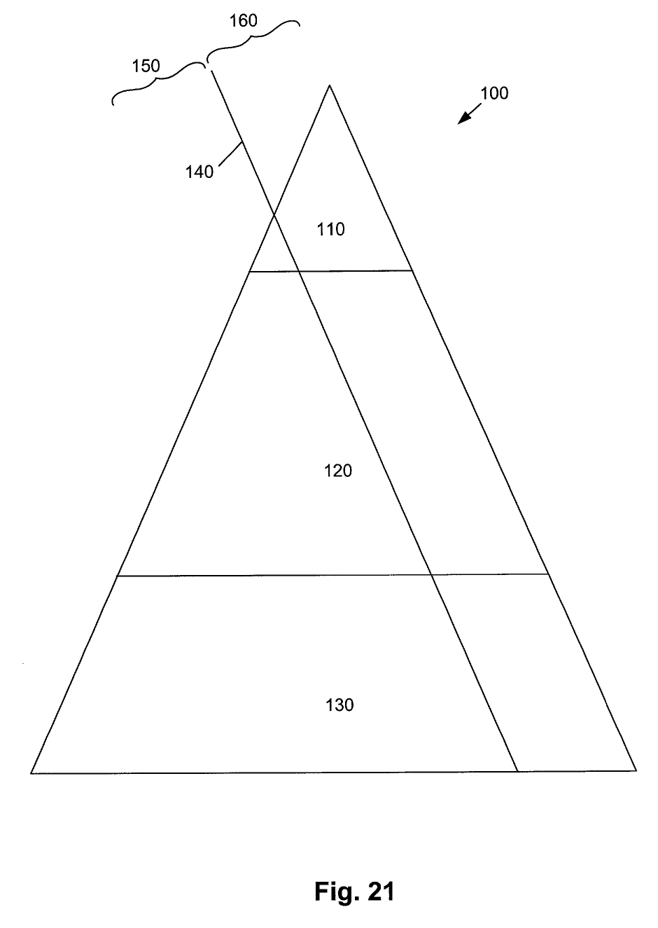

Embodiments of the invention relating to the creation of custom fragrances will now be described with reference to FIGS. 21-24. FIG. 21 includes a fragrance triangle 100 for the purpose of illustrating various specific embodiments of the invention. It is well known that fragrances typically comprise a combination of base notes 130 (also denoted bottom notes or base components), middle notes 120 (also denoted middle components), and top notes 110 (also denoted top components).

Exemplary base notes, middle notes and top notes are discussed in U.S. Pat. No. 5,354,737, the entire disclosure of which is incorporated herein by reference for all purposes. Base notes are characterized by components with long-lasting character. Musk is one example of a base note. Base notes typically have a higher molecular weight than other notes.

Middle notes have a lower molecular weight than base notes, but higher molecular weight than top notes. Top notes are characterized by their high volatility and low molecular weight. Jasmine is one example of a top note. Middle notes 120 of triangle 100, have a molecular weight that is higher than the top notes 110 and lower than the base notes 130, middle notes 120 and base notes 130 provide the longevity of the fragrance, such as the smell after several hours that the fragrance was first placed on an individual's skin. The top notes 110, on the other hand, typically dominate the smell of the fragrance when the fragrance is first placed on the skin of an individual. Because top notes 110 are more volatile than middle and base notes (120, 130), the top notes 110 dissipate more quickly. The molecular weight of the top notes is generally much lower than the molecular weight of the middle and base notes.

In accordance with the teachings of the present invention, diagonal line 140 is added to the conventional fragrance triangle. Diagonal line 140 partitions triangle 100 to provide a boundary between a first fragrance 150 and a second fragrance 160. The first fragrance 150 comprises at least one top note 110, at least one middle note 120, and at least one base note 130. In a presently preferred embodiment, the first fragrance 150 is dominated by the base and middle notes (i.e., it comprises no more than 30% (by volume) top note. The second fragrance 160 is also comprised of at least one top note 110, at least one middle note 120, and at least one base note 130. The second fragrance 160 is dominated by the more volatile top note 110 and the middle note 120 (i.e., it comprises 30% (by volume) or more of top note). The second fragrance 160 is also comprised of at least one top note 110, at least one middle note 120, and at least one base note 130. The second fragrance 160 is dominated by the more volatile top note 110 and the middle note 120.

Based on the teaching of the present invention, it will be readily apparent to those of skill in the art that the fragrance triangle illustrated in FIG. 21 can be diagonally partitioned using multiple diagonal links 140, thereby producing a plurality of fragrances, each fragrance having a base note, middle note, and top note, and any number of which can be combined to produce a customized fragrance.

The first fragrance 150 (also denoted herein by the term “hearts”) and the second fragrance 160 (also denoted herein by the term “souls”) can be combined in any ratio. In a preferred embodiment, the ratio of the first fragrance to second fragrance (i.e., hearts:souls) ranges from 90:10 (by volume), more preferably 80:20 (by volume), more preferably 70:30 (by volume), more preferably 60:40 (by volume) and given more preferably 50:50 (by volume).

One advantage of the present invention enabled by the novel fragrance triangle partitioning described above is that both the hearts 150 and the souls 160 represent independently viable fragrances. Because each of the hearts 150 and souls 160 have top, middle, and base notes, each of the hearts 150 and souls 160 can themselves be viable fragrances on their own. Thus, it can be determined through field trials whether individual hearts 150 and souls 160 are appealing fragrances. Using field trials, or other means, a subset of appealing hearts 150 and souls 160 can be identified. Once this set of appealing hearts 150 and souls 160 is identified, these hearts 150 and souls 160 can be used as the set of fragrance combinations from which a consumer may select a particular heart 150 to be combined with a particular soul 160. Because it will already have been determined that individual hearts 150 and souls 160 are independently appealing fragrances, there is a high probability that the combination of a particular heart 150 and a particular soul 160 will also be an appealing combination. The process used in the present invention for enabling a consumer to select a particular heart 150 and a particular soul 160 for combination into a combined customized fragrance is described below.

In order to select the fragrance 150 and the second fragrance 160, an individual, such as a consumer, must respond to a series of questions to determine the consumer's particular tastes. To select a particular first fragrance 150, the individual is required in one embodiment, to respond to four questions. The first question relates to the time of day that the individual expects to be using the fragrance and the effect that fragrance has during the day when it may be at a higher temperature compared to its effect if the individual was wearing the perfume in the evening. The second question relates to the occasion at which the individual intends to wear the fragrance. For example, the individual may be seeking a fragrance that is acceptable in a casual setting as opposed to a very special or more formal setting. The third question relates to the mood that the individual seeks to evoke from others. For example, the mood that the individual may seek to set is a confident mood, a seductive mood, a feminine mood, a calm mood, or an energized mood. The fourth question relates to whether the individual is seeking to provide a traditional or trendy smell. It will be apparent to those of ordinary skill in the art that other queries for determining an individual's tastes or performances may also be employed. Such inquiries may relate to demographics, geographies and/or psychographics and include, for example, past consumer behavior and selections, age, ethnicity, skin-type (oily or dry), location, etc. The computer, evaluator and/or manufacturer will match these responses to determine the selected first fragrance 150. For example, if a woman is seeking to wear the fragrance during the daytime, and she desires to have a trendy effect with an energized mood on a casual occasion, a Marine fragrance would be selected as the first fragrance 150. In yet another example, if the woman is to wear the perfume in the evening and desires a seductive mood for a special occasion and she also desires to be trendy, a Gourmand fragrance would be selected as the first fragrance 150.

After selecting the first fragrance 150, a second fragrance 160 is then selected, based, in part, on the particular first fragrance 150 selected. In particular, the selection of a first fragrance 150 will rank and narrow the available second fragrance 160 to only those that are most highly compatible with the selected first fragrance 150. In this manner, the present invention will produce a combined customized fragrance that is very likely to be appealing to the targeted market. In order to further select the second fragrance 160, in one embodiment, additional questions are posed to the individual. For example, a question relating to where a person wishes to evoke a sense of transportation to a fantasy location, such as Florence, Italy, or other memorable location is asked. Similarly, a question relating to whether the fragrance is going to be worn in a particular season, such as spring, summer, fall, or winter is asked.

For example, if a Marine fragrance is selected as the first fragrance 150, and if a woman has the fantasy to be transported to Venice, Italy in the spring, then Fresh Marine is selected as the second fragrance 160. However, three souls would be selected as being highly compatible with the selected first fragrance 150 (e.g., white flower, fresh marine and green floral), with the white flower being designated as the most preferred choice for the second fragrance 160.

In one embodiment of the present invention, the selection of a customized of fragrance is facilitated by displaying imagery consistent with the time, mood, setting, market trend, and occasion selected by the consumer in response to the questions described above. For example, during the selection of a heart 150, the consumer may select a casual, modern setting during the daytime. If such a selection is made, a “marine” fragrance 150 selection is conveyed to the consumer through imagery consistent with such a setting. For example, a daytime beach scene may be portrayed to convey the selections made by the consumer.

In one embodiment, once the consumer responds to each of the queries described above, the present invention matches the queries to the available heart fragrances 150. The present invention identifies three (or a lesser or greater number) heart fragrances 150 that most closely match the consumer's answers to the posed questions. Imagery consistent with these three matched heart fragrances 150 is returned and displayed for the consumer. The consumer may then make a final selection of heart fragrance 150.

A similar process is used for the selection of soul fragrances 160. A series of questions is used to determine a season and evocative setting associated with the consumer's answers. The best three (or a lesser or greater number) soul fragrances 160 that most closely match the consumer's answers are identified. Imagery consistent with these three matched soul fragrances 160 is returned and displayed for the consumer. The consumer may then make a final selection of soul fragrance 160.

Having identified the consumer selected heart fragrance 150 and the consumer selected soul fragrance 160, the combined user-customized fragrance is thus identified. The resulting customized fragrance is the combination of the selected heart 150 and the selected soul 160. As described above, the combined fragrance has a high probability of being an appealing fragrance and can be further customized or optimized to the particular consumer's wishes. Needs or desires customized may also be conveyed to the consumer through imagery and audio corresponding to the selected heart 150 and the selected soul 160.

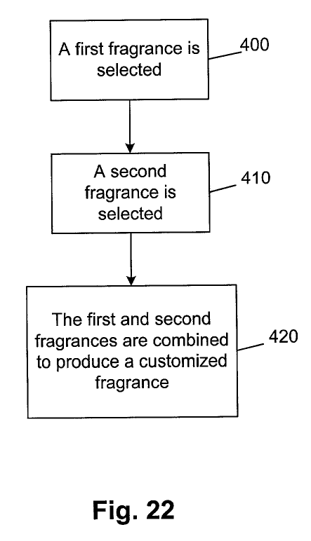

FIG. 22 illustrates a flow diagram of selecting fragrances to form a mixture of fragrances. At block 400, a first fragrances 150 is selected by selecting at least one base note, at least one middle note, and at least one top note. At block 410, a second fragrance 160 is selected by selecting in at least one base note, at least one middle note, and at least one top note. At block 420, the first fragrance 150 and the second fragrance 160 are combined to form a customized fragrance.

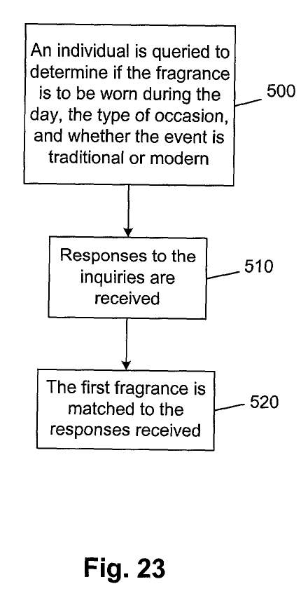

FIG. 23 illustrates a flow diagram of selecting a first fragrance 150 in accordance with one embodiment of the invention. At block 500, an individual is asked for example, when the perfume is to be worn (e.g., during the day), the type of occasion that the perfume is to be worn, the desired mood that the perfume is intended to present, and whether the event is traditional or new. At block 510, responses to these inquiries are received from the individual. At block 520, the first fragrance 150 is matched to the responses received to the questions posed at block 500.

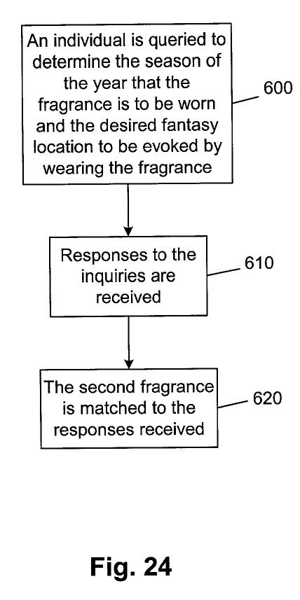

FIG. 24 illustrates a flow diagram illustrating the manner in which the second fragrance 160 is selected. At block 600, questions are posed to the individual as to the season of the year, such as spring, summer, fall, winter, that the perfume is to be worn and the desired physical location to be evoked from wearing the perfume. At block 610, the responses to these questions are received from the individual. At block 620, the second fragrance 160 is matched to the responses received from the individual.

In one embodiment, the process of enabling a user to make selections from a set of hearts 150 and a set of souls 160 to produce a customized fragrance can be implemented on a computer network, such as the Internet. It is important to note that the present invention can be equivalently implemented without the use of computers.

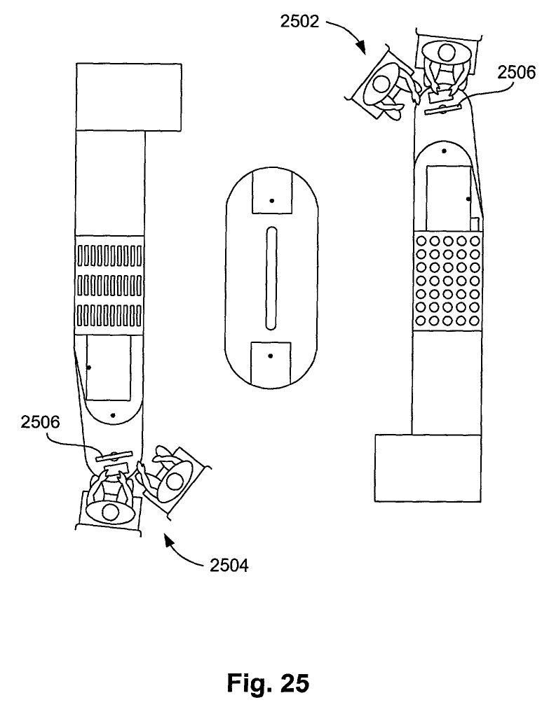

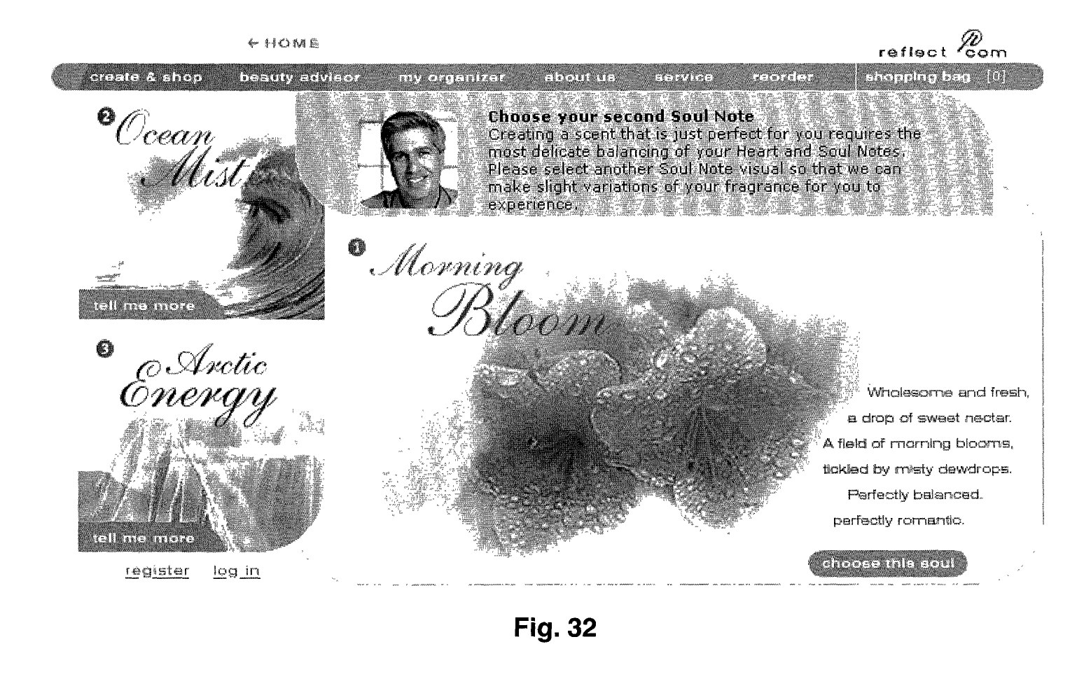

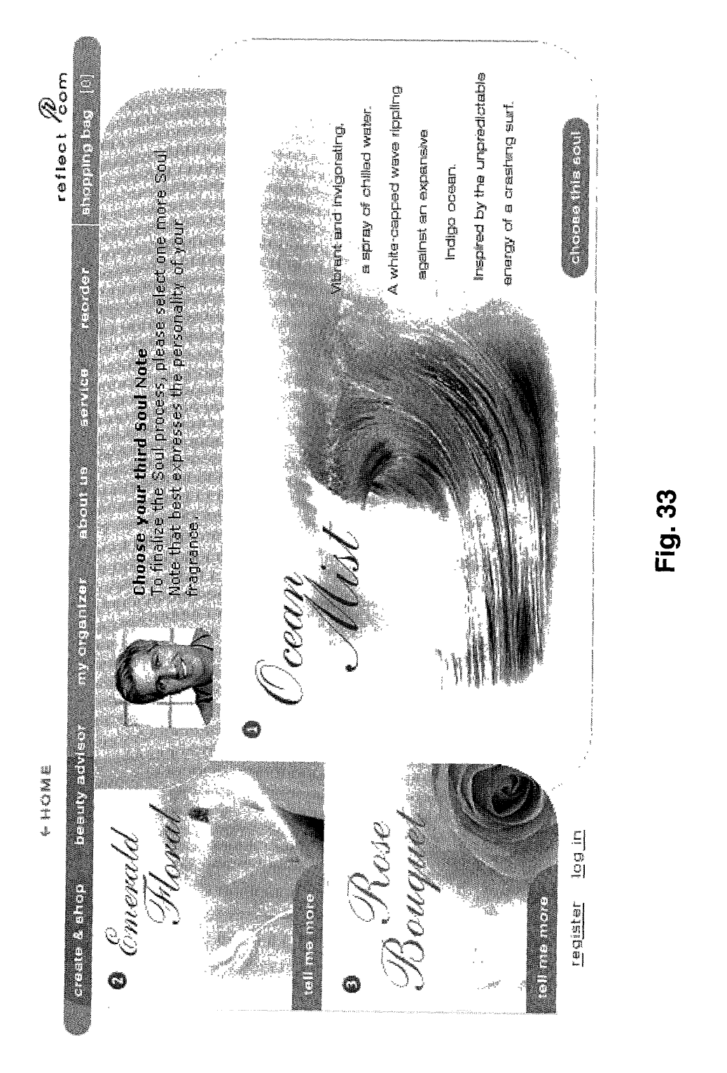

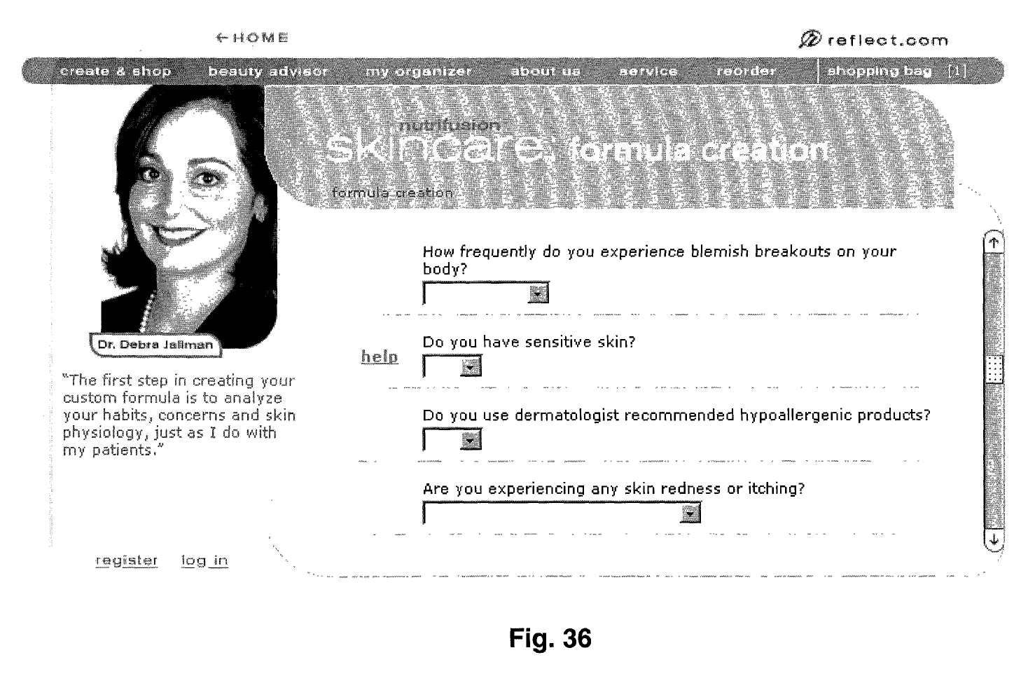

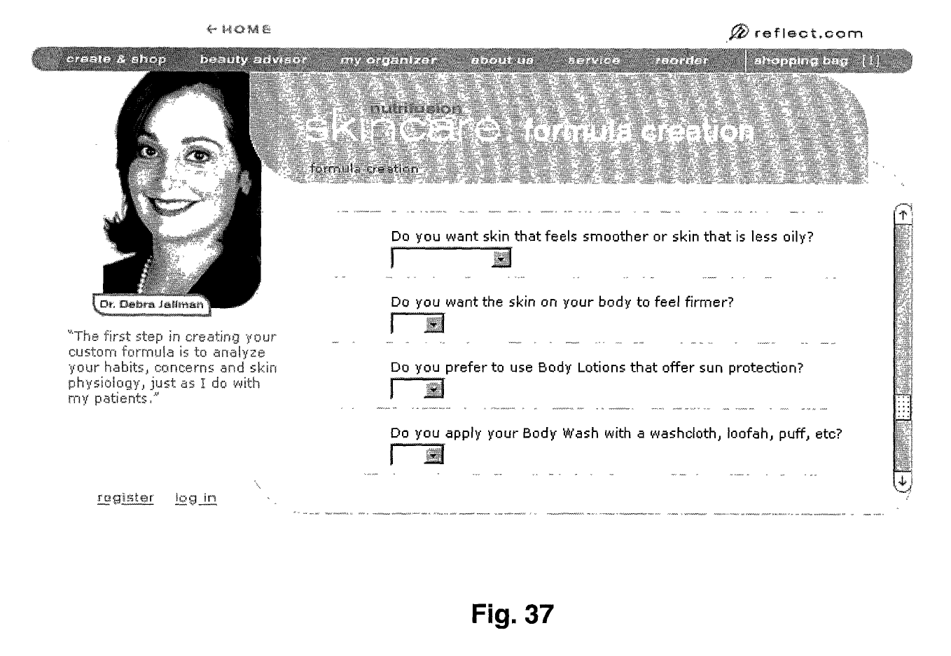

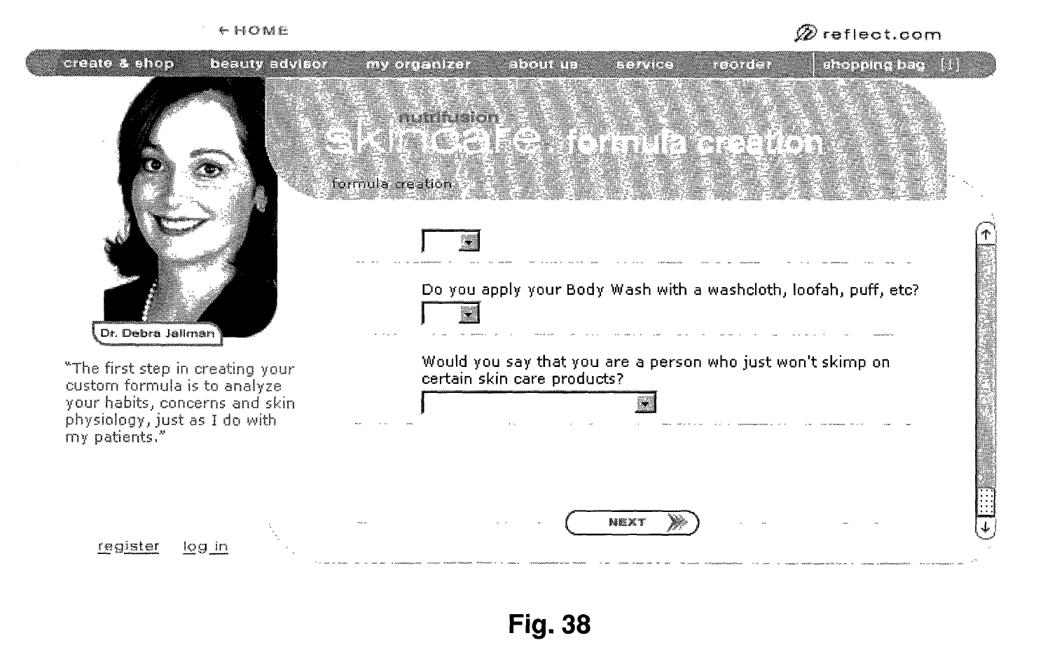

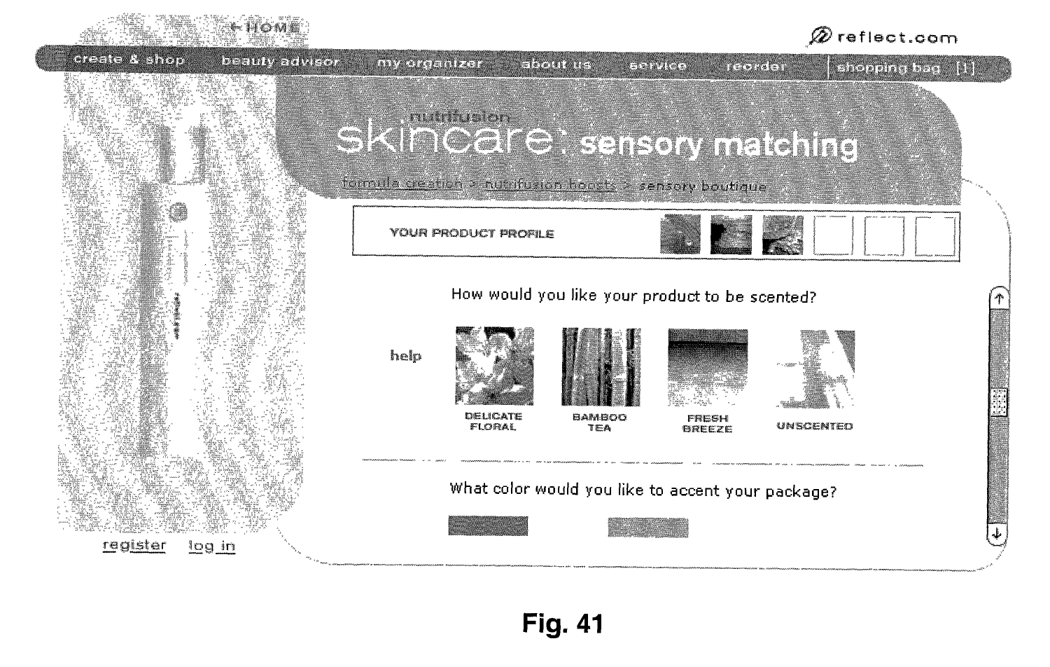

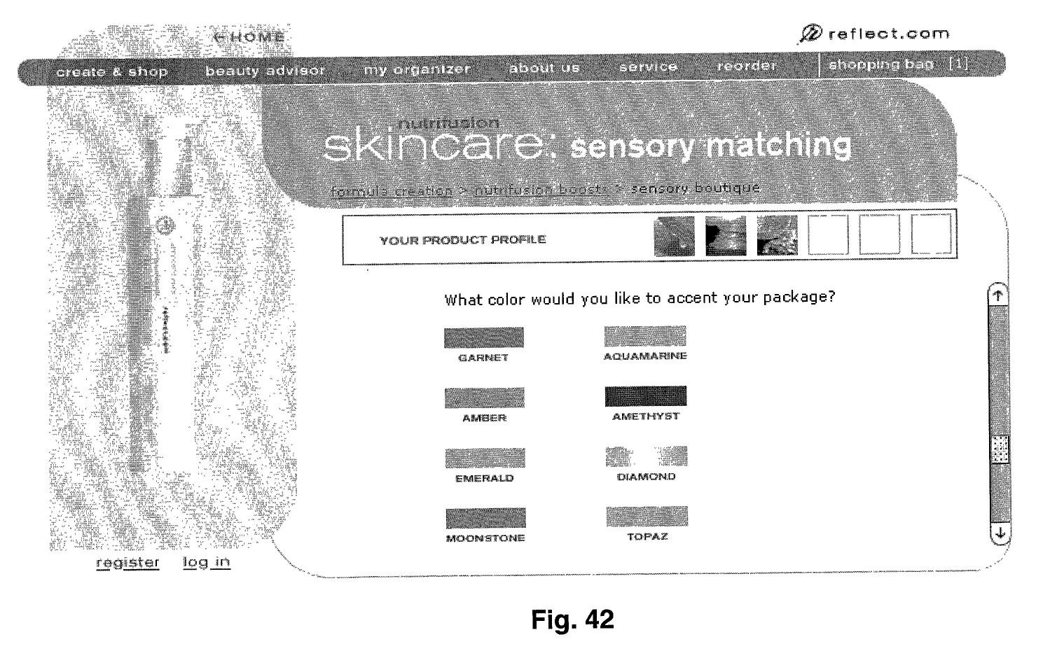

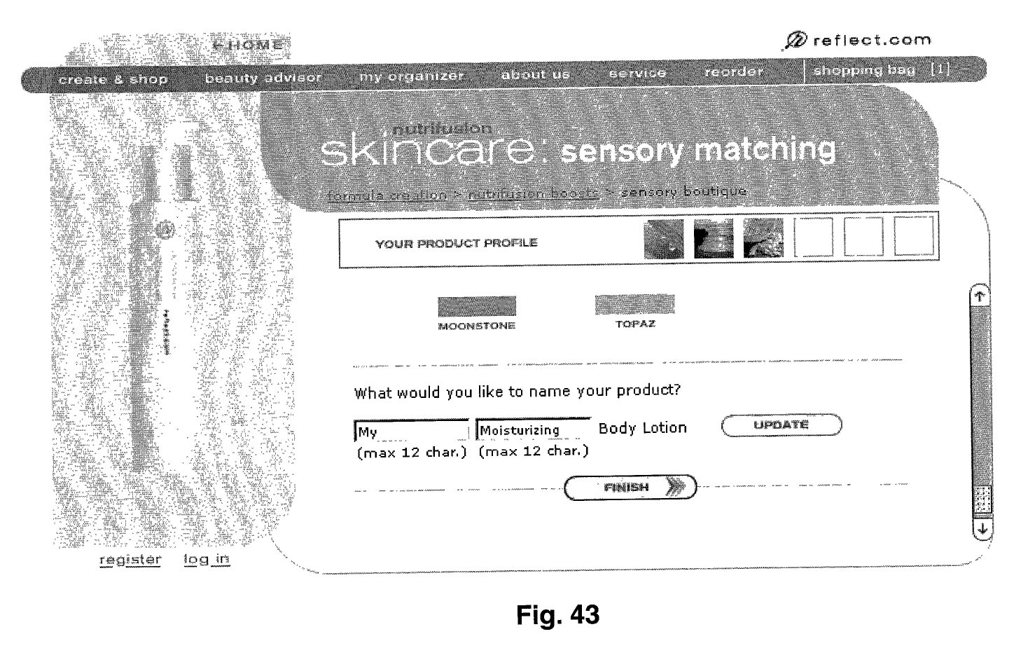

Specific embodiments of the present invention for synthesizing and distributing beauty and/or personal care products in a retail setting will now be described with reference to FIGS. 25-43. It will be understood that various aspect of the embodiments described above may be employed to implement similar aspects of these retail embodiments. The details of such aspects may therefore not be described below to avoid repetition of subject matter.

According to variations of the following embodiments, the personal care products to which the description refers may include body wash, body lotion, body scrub, hand creme, eye treatment, facial moisturizer, facial cleanser, facial balancer, face scrub, face mask, eye shadow, eye liner, mascara, lipstick, lipliner, foundation, blush, powder, concealer, shampoo, conditioner, and fragrances. It will be understood that the foregoing list is not exclusive and that embodiments of the present invention are contemplated in which other types of personal care products are synthesized.

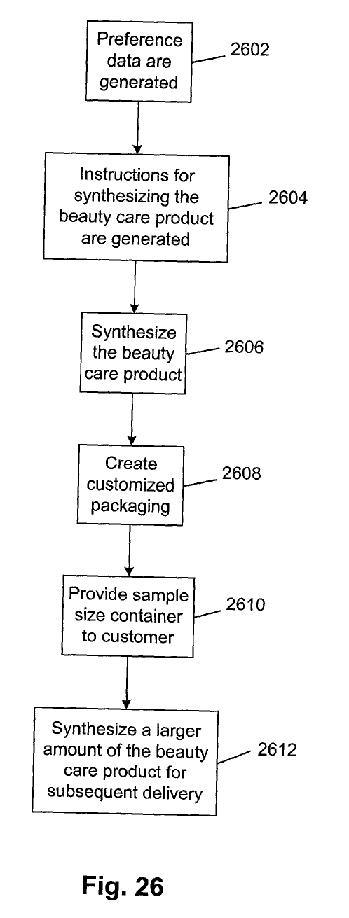

FIG. 25 is an overhead view of a retail environment in which embodiments of the present invention may be practiced. FIG. 26 is a flowchart illustrating a generalized embodiment of the present invention in such a retail environment. Referring specifically to FIG. 25, two different custom personal care product stations are shown, fragrance center 2502 and skin care center 2504. Each center is equipped with a stand alone or networked computing device (e.g., computers 2506) by which various aspects of the invention may be practiced. Each center may be staffed by a consultant with expertise in the appropriate field who may walk the customer through the process. Subsequent discussions of the present invention will assume this paradigm. However, it should be understood that the present invention includes embodiments in which the process is self-directed by the customer.

During the course of an interview of the customer by the consultant, preference data relating to the type of personal care product desired are generated (2602). According to a specific embodiment, these preference data may include not only the preferences of the customer with regard to particular attributes of the products, but the physical attributes and characteristics of the customer herself (e.g., skin type, hair color, eye color, etc.).

This part of the process typically involves having the customer answer a series of questions relating to the personal care product and the customer's preferences in relation thereto. Examples of such questions are discussed above and below. According to various embodiments, these preference data may be elicited in a variety of ways including, for example, a private interview with a consultant using manual transcription or a series of graphical user interfaces, or a self-directed process in which the customer navigates the interfaces themselves.

As discussed above with reference to online creation of personal care products, this process may be conducted using a similar series of graphical user interfaces to generate the preference data. According to a specific embodiment, computers 2506 are part of a networked system in which the graphical user interfaces are served to computers 2506 from a remote server, and various parts of the process are performed remotely by the server or other parts of a back end system.

Once the preference data have been generated, instructions for synthesizing the personal care product are generated in a format perceivable and understandable by humans (2604). For example, step-by-step instructions may be provided in the graphical user interface of computer 2506. Alternatively, the instructions may be printed out on paper or a specially sized instructions card. According to yet another alternative, audio representations of the instructions may be provided using, for example, a speech synthesizer or pre-recorded voice fragments.

However, the instructions are communicated, the consultant then synthesizes the personal care product from materials on hand (2606). According to various embodiments, this synthesis may be accomplished using any of a wide variety of tools and techniques. The important aspect of these embodiments, is the reproducibility of the result. That is, through the use of the synthesis instructions (which may be permanently stored for future use), and precise delivery of the components of the personal care product, a highly reproducible end product is the result.

Precise delivery of the constituent ingredients of the personal care product may be accomplished in a variety of ways without departing from the scope of the invention. For example, where the personal care product comprises various amounts of different fluids, precise fluid delivery mechanisms may be employed to dispense the various components. Alternatively, previously measured increments of product components may be provided in individual packages which may be opened when needed. It will be understood that many other alternative ways of providing the desired precision and repeatability are within the scope of the invention.

Customized packaging for the product is then created with input from the customer as to various aspects of the labeling (2608) such as, for example, the product name, color accents, etc. A sample or full size container of the synthesized personal care product may then be provided to the customer before she leaves the store (2610). The instructions for synthesizing the personal care product are the also employed at a manufacturing facility to synthesize a larger amount of the personal care product for subsequent delivery to the customer (2612) either at an address designated by the customer, or at the retail location for pick up. According to some embodiments, the manufacturing facility is interconnected directly or indirectly with the retail location via, for example, a wide area network, thus facilitating the exchange of the necessary information.

As will be understood with reference to the foregoing description, these embodiments of the present invention combine the advantages and desirable aspects of custom product generation with the immediate satisfaction of the retail experience. The present invention makes such an approach feasible because of the reproducibility of results. That is, the instructions and the precise component delivery generates a sample on the spot, thus allowing the customer to decide whether she likes the product and to leave with the product virtually immediately.

According to a specific embodiment, in addition to storing the instructions for reference, a product description may also be stored and associated with the instructions for subsequent access by the customer. Such a product description might identify ingredients, the product name devised by the customer, or any other product attribute or characteristic by which the product may be specifically identified. This allows the customer to have a reference point for subsequently requesting additional amounts of the product which can be faithfully reproduced to ensure continued customer satisfaction. According to specific embodiments, the product description is stored in a back end server and can be retrieved by the customer online (either at home or in store), or by retail personnel in response to a customer request.

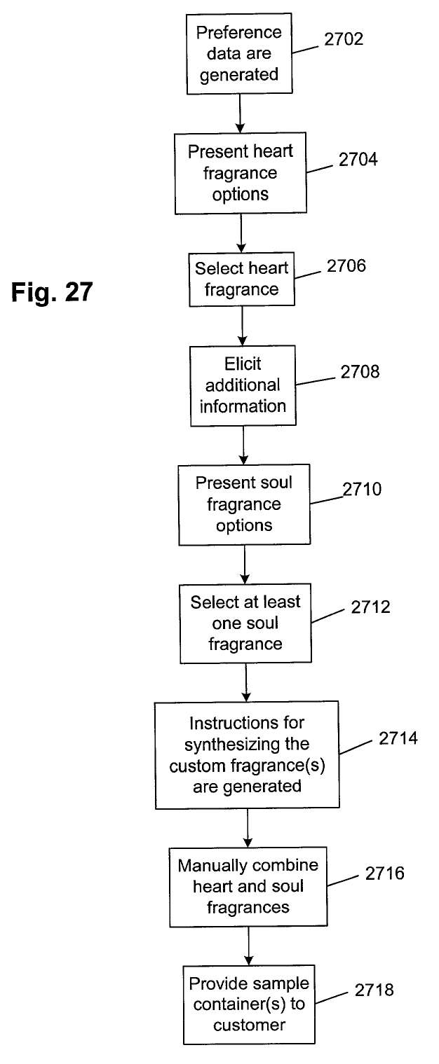

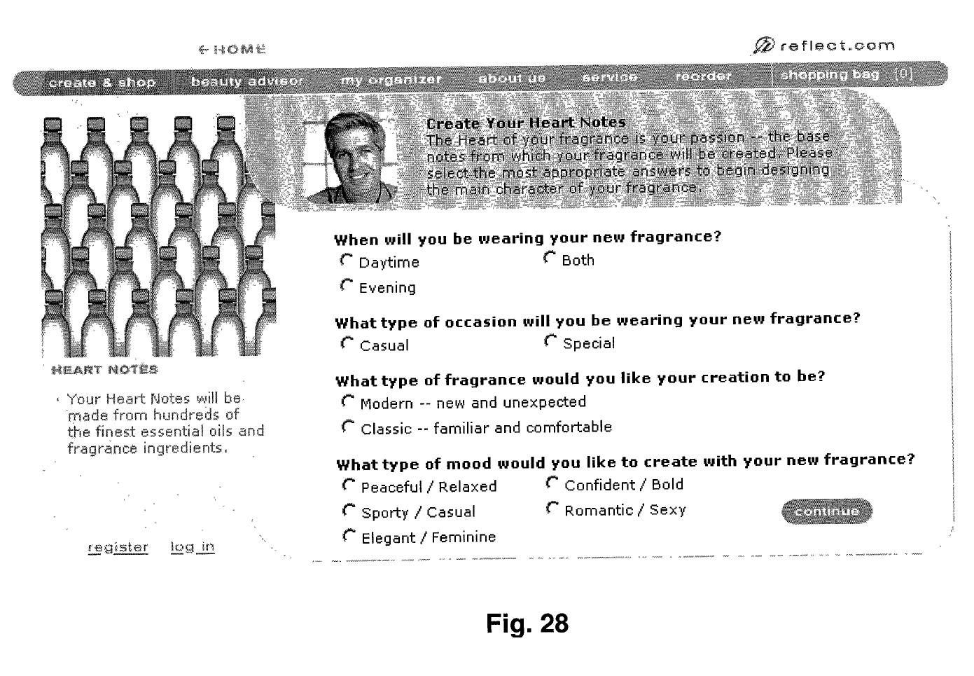

A more specific embodiment of the invention illustrating the process of synthesizing a fragrance in a retail environment will now be described with reference to the flowchart of FIG. 27 and the screen shots of FIGS. 28-33. As will be understood, many of the aspects of the invention discussed above with reference to FIGS. 21-24 apply to this embodiment.

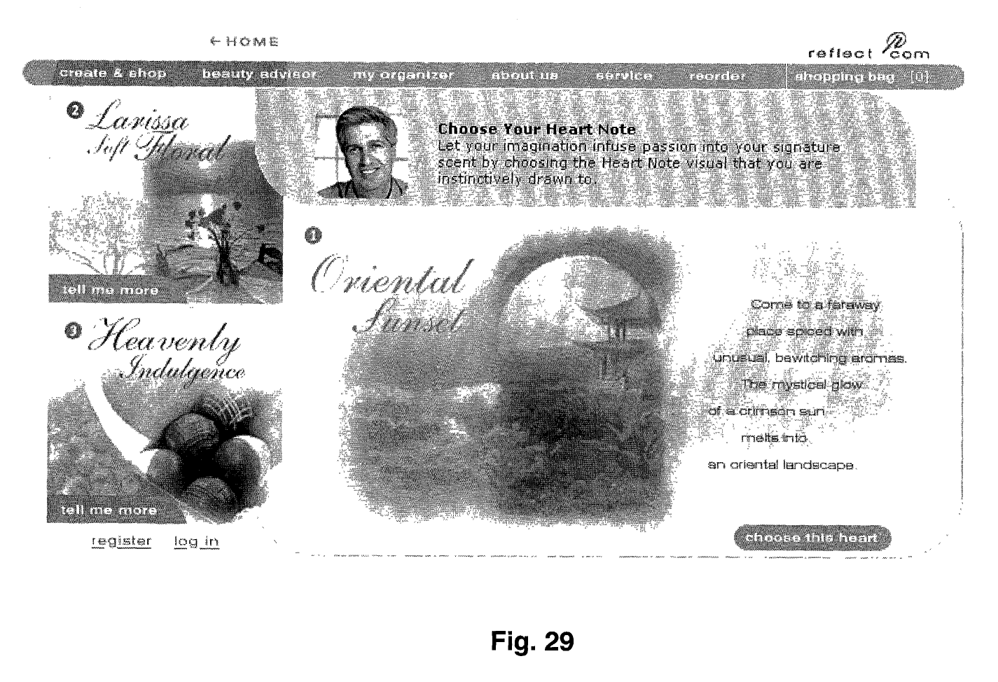

During the initial phase of the consultation process, first preference data are generated which are representative of the customer's expressed preferences with regard to fragrances, e.g., when the fragrance is to be worn and the mood to be evoked (2702), and which are intended to be used to identify a heart fragrance as described above with reference to FIG. 23. As mentioned above, these preference data may be generated in a variety of ways including everything from manual recordation to the use of one or more graphical user interfaces. An exemplary graphical user interface which may be used by the consultant to record such information is shown in FIG. 28. A number of options for heart fragrances corresponding to the first preference data are then presented to the customer for selection of a heart fragrance (2704) as shown, for example, in FIG. 29. The heart fragrance is then selected by the customer (2706).

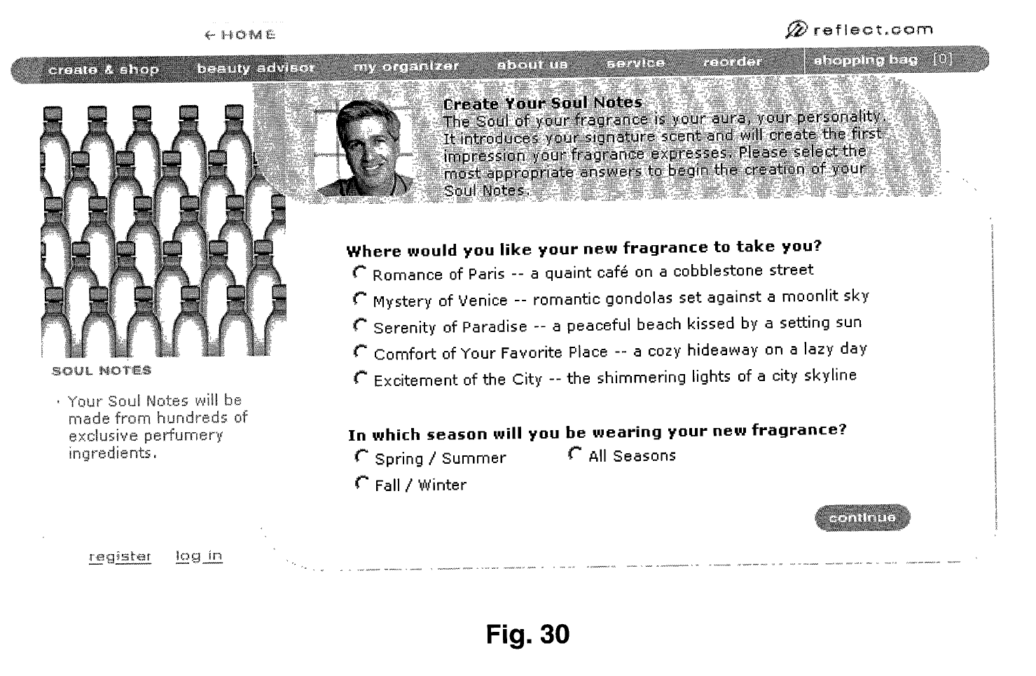

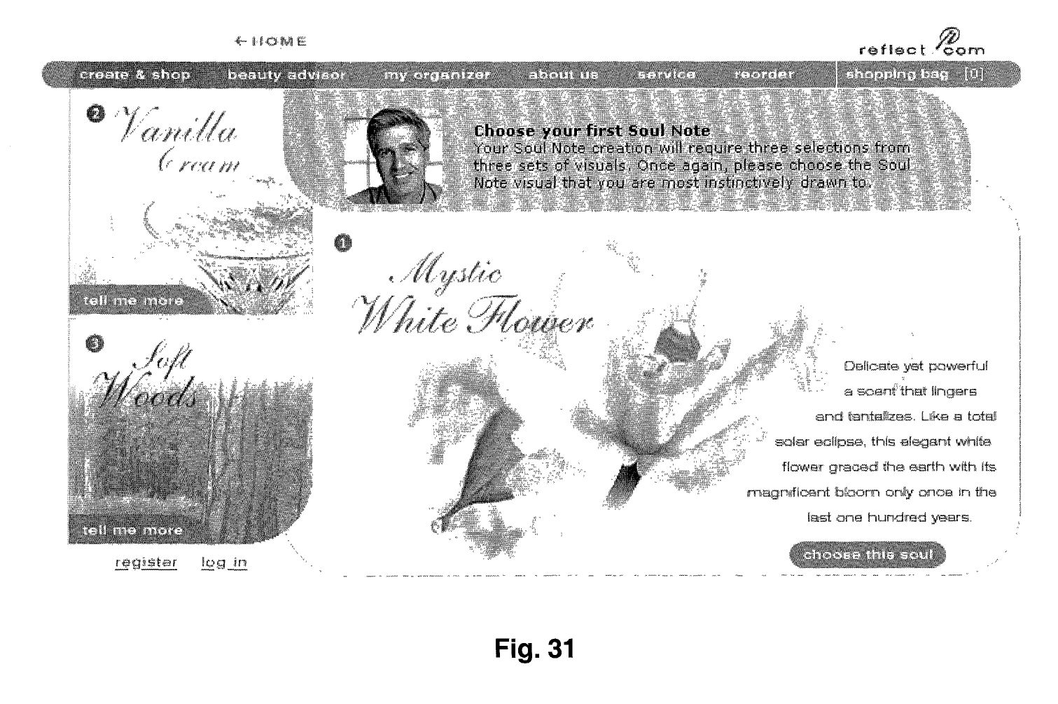

Additional information is then elicited from the customer to determine a second fragrance, i.e., a soul fragrance, for combination with the heart fragrance (2708). An exemplary graphical user interface for recording such information, e.g., a fantasy location to be evoked, is shown in FIG. 30. The customer is then presented with a number of options for soul fragrances which correspond to the elicited information (2710). According to a specific embodiment and as shown in FIGS. 31-33, the customer is presented with multiple sets of visual images, each of which represents a soul fragrance which may be combined with the selected heart fragrance. The customer selects one or more of the presented options to generate a corresponding number of customized fragrances (2712). Instructions for synthesizing the one or more customized fragrances are then generated in a format perceivable and understandable by humans (2714). As discussed above, this format may take a variety of forms.

The consultant then manually synthesizes the one or more custom fragrances in the retail environment in accordance with the instructions by combining the heart and soul fragrances (2716). As discussed above, this process is made precise and repeatable using any of a variety of technologies for dispensing or pre-measuring the constituent fragrances. In this way, one or more sample sizes of the custom fragrances may be provided to the consumer before the consumer leaves the retail environment (2718). This allows the customer to determine on the spot whether she likes any of the fragrances and, if so, enables her to leave the store with the customized product in hand. As discussed above, custom packaging and labeling may also be provided to further enhance the customer's experience.

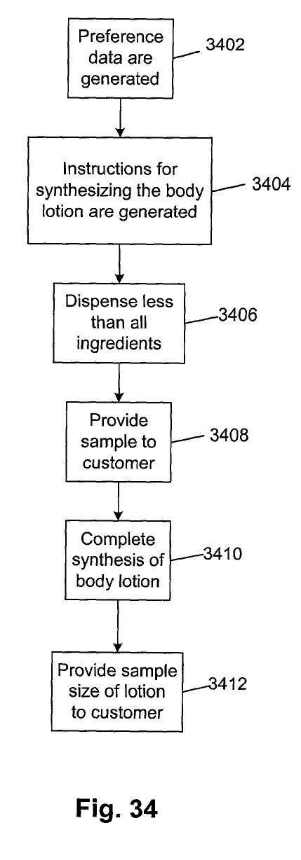

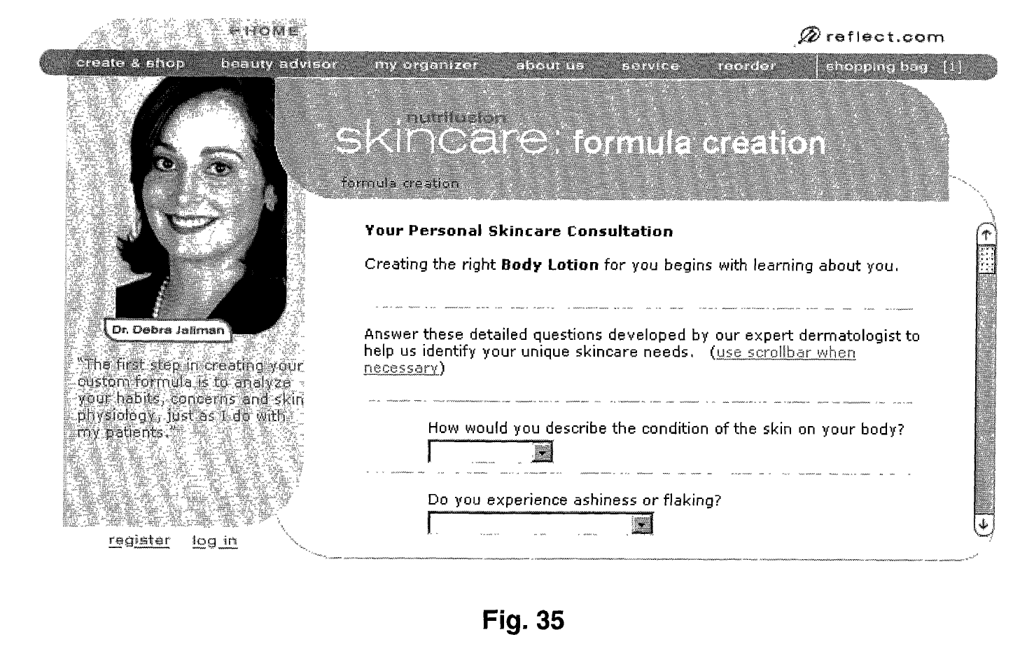

Another specific embodiment of the invention illustrating the process of synthesizing a body lotion in a retail environment will now be described with reference to the flowchart of FIG. 34 and the screen shots of FIGS. 35-43. As will be understood, this embodiment may be employed to synthesize any type of personal care product formulation and that a body lotion is shown for exemplary purposes. It will also be understood that many of the aspects of the invention discussed above with reference to FIGS. 1-20 apply to this embodiment.

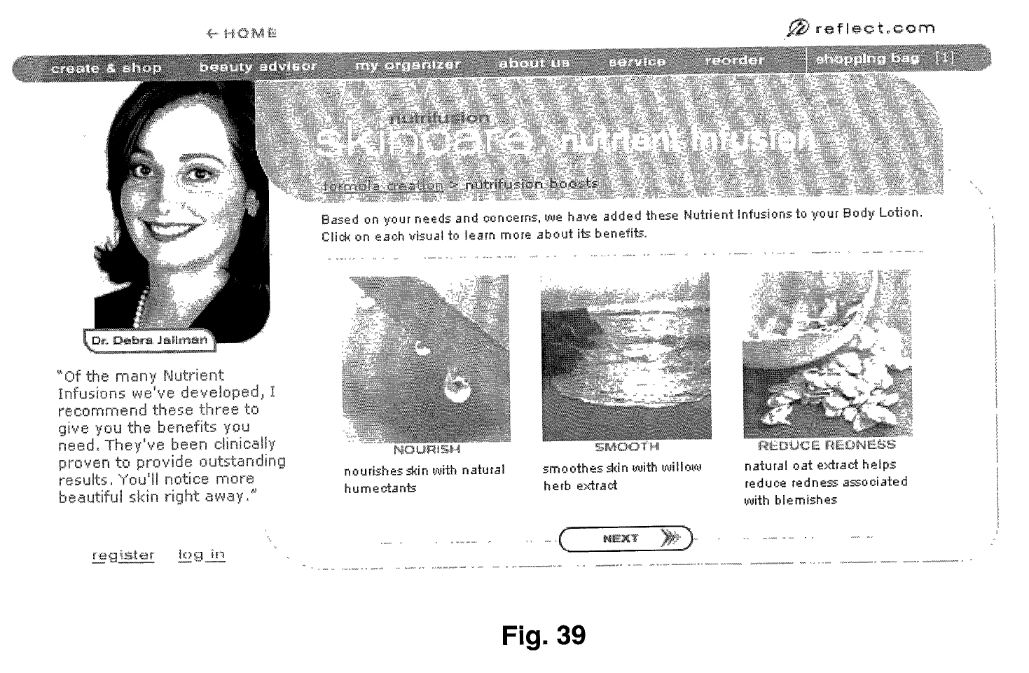

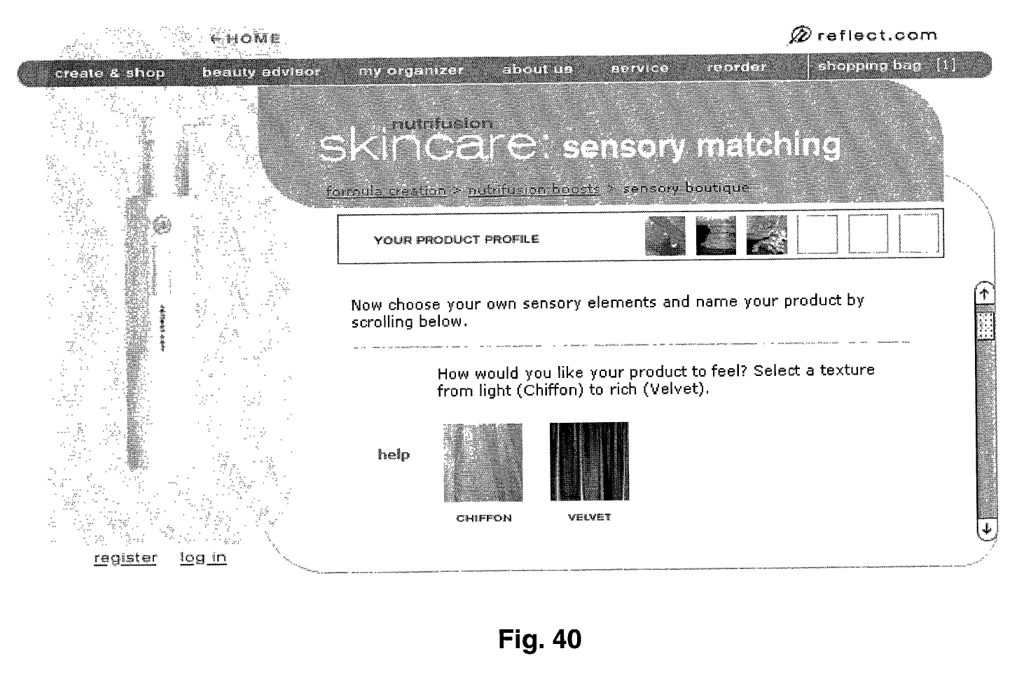

During the initial phase of the consultation process, preference data representative of the expressed preferences of a customer with regard to personal care products are generated (3402). As mentioned above, these preference data may be generated in a variety of ways including everything from manual recordation to the use of one or more graphical user interfaces. FIGS. 35-43 illustrate some exemplary graphical user interfaces which may be employed by the consultant to elicit the necessary information. For example, the interfaces of FIGS. 35-38 are intended to elicit dermatological and general preference information which will guide the selection of the constituent components of the end product. The interface of FIG. 39 identifies some nutrient infusions identified based on the information elicited in FIGS. 35-38 which may be added to the end product, and about which additional information may be provided. The interfaces of FIGS. 40-43 are intended to elicit further information for the purpose of providing additional levels of personalization of the end product in accordance with various sensory preferences expressed by the customer.

In response to the preference data, instructions for synthesizing the body lotion are generated which identify a plurality of components (e.g., a chassis lotion, nutrient infusions, fragrance, etc.) in a format perceivable and understandable by humans (3404). According to a specific embodiment, the consultant may manually dispense and/or combine less than all of the identified components to synthesize an intermediate formulation (3406) and provide a sample of the intermediate formulation to the customer (3408). In this way, characteristics such as texture or oiliness may be experienced before the end product is complete.

If the customer expresses satisfaction with the intermediate product, the consultant may complete the manual synthesis of the lotion in accordance with the instructions (3410) and provide a sample or full size to the customer before she leaves the retail environment (3412).

According to another embodiment, the processes of FIGS. 26 and 34 may be employed to simultaneously generate multiple products using the information elicited from the customer via an interviewing process or via the user interfaces mentioned above. That is, for example, an array of complementary skin care or hair care products might be developed using a single set of questions, some of which may be relevant to all of the products to be created, and some of which might be directed to aspects of only one or a subset of the products. Examples of related skin care products might include body lotion, hand creme, and facial moisturizer, etc. Examples of related hair care products might include shampoo, conditioner, detangling spray, etc.

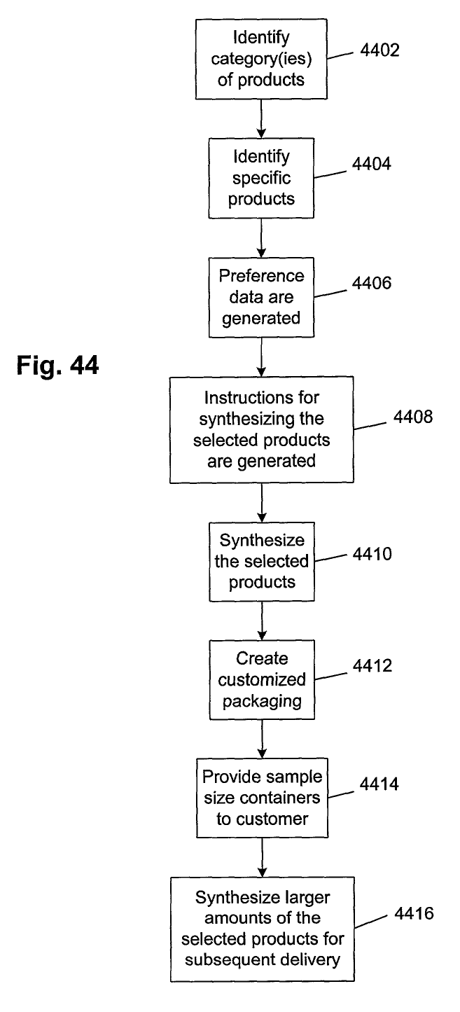

An embodiment of the invention for creating multiple related products will now be described with reference to FIG. 44. According to a specific implementation, the products are related products in a single category of products, e.g., hair care. According to a more generalized implementation, any set of custom personal care products having varying degrees of relation to each other may be simultaneously created. For example, shampoo and conditioner (hair care products) may be simultaneously created with a body wash (skin care product) for a customized bathing system. Alternatively, a moisturizer (skin care product) may be simultaneously created with a foundation and mascara (cosmetic products) for a customized cosmetic system. Stated more generally, the techniques of the present invention may be employed to create a customized system of customized personal care products.

As an initial part of the consultation, the customer is asked to identify a category or categories of products in which she has an interest (4402). For example, the customer might want an array of complementary products from a single category, e.g., skin care products. Alternatively, the customer might want products from different categories, e.g., eye creme (skin care product) and foundation or concealer (cosmetic product). For each category selected, an array of specific products is identified from which the customer can select (4404). For example, if the customer selects skin care products, the array of products might include facial moisturizer, facial cleanser, balancer, eye treatment, body wash, body lotion, hand creme, etc. Alternatively, if the customer selects hair care products, the array of products might include shampoo, conditioner, clarifying shampoo, hair spray, defining wax etc. It will be understood that the categories and the corresponding products may vary considerably without departing from the scope of the invention. According to various embodiments, the customer may identify multiple products from a single category or one or more from each of multiple categories.

According to a specific embodiment, the customer's choices may prompt presentation of other suggested related and/or complementary products. For example, if the customer selects body wash as part of her customized personal care system, the system of the present invention may then indicate that she may also select shampoo and conditioner to complete the bathing regime of her system. It will be understood that the manner in which the various product types in a system designed according to the invention are interrelated, and the manner in which such interrelations may be used to suggest additional product selections may vary considerably and still remain within the scope of the present invention.

In response to selection of some set of products the generation of preference data representative of the customer's preferences with regard to the selected products is done (4406). As mentioned above, these preference data may be generated in a variety of ways including everything from manual recordation to the use of one or more graphical user interfaces.

According to a specific embodiment, the questions employed to elicit the preference data are determined with reference to the products selected. That is, for example, where graphical user interfaces are employed to elicit the customer's preferences, only questions useful for eliciting the information necessary to create the products selected by the customer are culled from one or more preexisting sets of questions and presented. According to another embodiment, the same set or sets of questions are employed for a particular category of product regardless of the specific products selected and the information elicited is used selectively with reference to the selected products.

Once the preference data have been generated, instructions for synthesizing each of the selected products are generated in a format perceivable and understandable by humans (4408). As discussed above, these instructions may be communicated and archived in a variety of ways.

According to a specific embodiment, instructions for more than one type of each selected product may be provided depending upon the preference data. That is, where the customer has identified facial moisturizer as one of the selected products, and where the customer has indicated that she spends a considerable amount of time in the sun or that she applies the moisturizer both in the morning and at night, two separate moisturizers may be created; one with an SPF ingredient and one without.

However the instructions are communicated and however many sets of instructions are generated, the consultant then synthesizes each of the products from materials on hand (4410). As discussed above, this synthesis is achieved using tools and techniques which ensure the quality and reproducibility of the result. Customized packaging for the products is then created with input from the customer as to various aspects of the labeling (4412) such as, for example, the product name, color accents, etc. A sample size container of each of the products may be provided to the customer before she leaves the store (4414). As discussed above with reference to FIG. 26, the instructions for synthesizing the personal care product are the also employed at a manufacturing facility to synthesize a larger amount of each of the products for subsequent delivery to the customer (4416).

According to an alternative embodiment, the customized system process described with reference to FIG. 44 may be practiced in a virtual environment, e.g., over the internet. That is, a consumer could log on to the appropriate URL, navigate the user interfaces presented and create a customized system comprising multiple customized products. One of the difference between this and the retail embodiments is that samples are not immediately available. Rather, such samples may be sent to the customer's home for testing, after which the manufacture and delivery of larger amounts of the products could be authorized by the consumer.

In addition, with such embodiments the instructions for synthesizing the products need not necessarily be rendered in human-readable form. That is, automated, back-end manufacturing processes may receive the instructions as any type of software or machine language representation, whereupon the products may be generated without human intervention. According to such embodiments, the instructions for synthesizing and/or ingredients list may ultimately be rendered in human-readable form, e.g., for labeling or other purposes. Of course, it will be understood that varying degrees of human interaction in the back-end manufacturing process and various modes of communication of the synthesis instructions are within the scope of the invention.

According to various retail and online embodiments, the simultaneously created products are recognized by the system of the present invention as a system and treated accordingly. For example, according to some embodiments, system discounts are applied (e.g., relative to the individual product prices), lowering the overall cost of the products and providing an incentive for the customer to create a personal care product system. According to various embodiments, such discounting may be done with reference to any of a plurality parameters including, for example, the personal care products themselves, the number of personal care products in the system, the individual prices of the products, relationships among the personal care products, e.g., the degree of inter-relatedness of the products, and the categories of personal care products to which the products belong.

While the invention has been particularly shown and described with reference to specific embodiments thereof, it will be understood by those skilled in the art that changes in the form and details of the disclosed embodiments may be made without departing from the spirit or scope of the invention. For example, both online and retail embodiments of the invention have been described with reference to specific details and various combinations of aspects. It will be understood, however, that these descriptions are not intended to be exclusive, and that various aspects of one embodiment may be employed in another implementation. For example, the computing systems of FIGS. 6 and 7 may be employed to implement various aspects of the retail embodiments of FIGS. 25-43. Similarly, any of the user interfaces described with reference to online embodiments of the invention may be employed to elicit information from a customer in a retail setting with only minor changes.

According to the various retail embodiments, additional user interfaces are provided to enable the in-store consultant or other personnel to perform various administrative functions including, for example, printing product synthesis instructions and accessing customer account information (e.g., to edit personal data and reorder previously synthesized products for particular customers).

Combinations of the various online and retail embodiments are also within the scope of the invention. According to some such embodiments, access may be provided in the retail setting to data previously generated from the customer's home computer. For example, the customer may have gone through the process of generating a signature fragrance from her home computer, but then decided that she wanted to sample the end product sooner than it could be delivered to her home. According to one embodiment, she may go to the closest retail location and, using the in-store system with the help of a consultant, retrieve the fragrance data for synthesis on the spot. As will be understood, there are a multitude of such synergistic combinations of various embodiments which are within the scope of the invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for synthesizing and distributing personal care products in a retail environment, comprising:
generating preference data in the retail environment, the preference data being representative of expressed preferences of a consumer with regard to personal care;
in response to the preference data, generating instructions for reproducibly synthesizing a first personal care product in a format perceivable and understandable by humans;
synthesizing the first personal care product in the retail environment in accordance with the instructions; and
providing the first personal care product to the consumer before the consumer leaves the retail environment.

2. The method of claim 1 wherein generating the preference data comprises employing a graphical user interface to record responses by the consumer to a series of questions.

3. The method of claim 2 wherein either of the consumer and a consultant employs the graphical user interface to record the responses.

4. The method of claim 2 wherein the graphical user interface is generated by either of a stand-alone computing device and a networked computing device.

5. The method of claim 2 further comprising employing the graphical user interface to retrieve previously generated data corresponding to the consumer.

6. The method of claim 5 wherein the previously generated data comprises at least one of identification data representing the consumer, and commercial behavior data representing previous commercial activity by the consumer.

7. The method of claim 1 wherein generating the instructions comprises any of providing the instructions in a graphical user interface, printing the instructions, and providing an audio representation of the instructions.

8. The method of claim 1 wherein synthesizing the first personal care product comprises manually combining predetermined amounts of at least two personal care product components according to the instructions.

9. The method of claim 8 wherein the predetermined amounts are provided via a manually operated dispensing system.

10. The method of claim 8 wherein the predetermined amounts are provided in previously measured increments.

11. The method of claim 1 wherein providing the first personal care product to the consumer comprises placing the first personal care product in a container, the method further comprising generating customized labeling for the container.

12. The method of claim 1 wherein providing the first personal care product to the consumer comprises providing the first personal care product to the consumer in a sample size container.

13. The method of claim 12 further comprising:
transmitting the instructions to a manufacturing facility;
synthesizing the first personal care product;
placing the first personal care product in a second container larger than the sample size container; and
sending the second container to either of an address designated by the consumer, and the retail environment.

14. The method of claim 1 further comprising storing the instructions for future synthesis of the first personal care product.

15. The method of claim 14 wherein storing the instructions comprises either of electronically storing instruction data representative of the instructions and storing a paper copy of the instructions.

16. The method of claim 14 further comprising synthesizing an additional amount of the first personal care product in response to a request from the consumer in accordance with the stored instructions.

17. The method of claim 1 wherein the first personal care product comprises a fragrance, the method further comprising identifying a first fragrance with reference to a first portion of the preference data, and identifying a second fragrance with reference to the first fragrance and a second portion of the preference data.

18. The method of claim 1 wherein the first personal care product comprises a final formulation comprising a plurality of components, the method further comprising combining less than all of the components to synthesize an intermediate formulation, and providing a sample of the intermediate formulation to the consumer.

19. The method of claim 1 wherein the first personal care product comprises any of a fragrance, a cosmetic product, a skin care product, and a hair care product.

20. The method of claim 19 wherein the final formulation comprises any of body wash, body lotion, hand creme, eye treatment, facial moisturizer, facial cleanser, facial balancer, shampoo, conditioner, body scrub, face mask, and face scrub.

21. A personal care product synthesized according to the method of claim 1.

22. A method for synthesizing a plurality of personal care products, comprising:
generating substantially simultaneously preference data representative of expressed preferences of a consumer with regard to personal care;
in response to the preference data, generating instructions for synthesizing each of the plurality of personal care products; and
synthesizing each of the personal care products in accordance with the instructions.

23. The method of claim 22 wherein the preference data are generated via a wide area network, and the personal care products are synthesized in a remote manufacturing facility.

24. The method of claim 22 wherein the preference data are generated in a retail environment, and the instructions for synthesizing the personal care products are generated in a format perceivable and understandable by humans.

25. The method of claim 24 wherein the personal care products are synthesized in the retail environment and provided to the consumer before the consumer leaves the retail environment.

26. The method of claim 22 further comprising presenting a plurality of questions to the consumer, the plurality of questions being selected from a preexisting set of questions with reference to the plurality of personal care products, the preference data being generated from responses to the questions.

27. The method of claim 22 further comprising identifying the plurality of personal care products as a customized system of products.

28. The method of claim 27 further comprising associating a discounted system price with the system.

29. The method of claim 28 wherein the discounted system price is less than a sum of individual prices associated with each of the personal care products.

30. The method of claim 28 wherein the discounted system price is less than a sum of individual prices associated with each of the personal care products and at least one other additional product.

31. The method of claim 22 wherein the instructions include a first set of instructions for synthesizing a first instance of a first one of the plurality of products and a second set of instructions for synthesizing a second instance of the first product.

32. The method of claim 22 further comprising selecting the plurality of products in response to selections by the consumer.

33. The method of claim 22 wherein the personal care products comprise any of a fragrance, a cosmetic product, a skin care product, and a hair care product.

34. A personal care product synthesized according to the method of claim 22.

35. A system of the personal care products synthesized according to the method of claim 22.
